(19) United States
(12) Patent Application Publication
(10) Pub. No.: US 2007/0082533 A1
(43) Pub. Date: Apr. 12, 2007

(54) One-touch connection and disconnection method and apparatus

(76) Inventors: Brian J. Currier, Newport, NH (US); Ronald Edward Morris, New London, NH (US)

Correspondence Address: PROSKAUER ROSE LLP, ONE INTERNATIONAL PLACE 14TH FL, BOSTON, MA, 02110, US

(21) Appl. No.: 11/394,371

(22) Filed: Mar. 30, 2006

Related U.S. Application Data
(63) Continuation-in-part of application No. 11/248,717, filed on Oct. 11, 2005.

(51) Int. Cl. H01R 13/627

(52) U.S. Cl. 439/352

(57) ABSTRACT

A first connector is disposed on a first end of a lead in a lead set for use with a plasma arc torch. The first connector is capable of engaging a second connector by causing a compression force in a second connector. The second connector compression force is caused by application of a translational force along a longitudinal axis. The second connector causes, upon application of a depression force along the longitudinal axis, disengagement of the first connector. The second causes disengagement of the first connector upon application of a linear force applied along the longitudinal axis to at least one of the first connector and the second connector. The second end of the lead may also be connected to a power supply. Methods for connecting and disconnecting a lead are also disclosed.

### RELATED APPLICATION

This application claims the benefit of and priority to and is a continuation-in-part of the U.S. patent application entitled “One Touch Connection and Disconnection Method and Apparatus” filed on Oct. 11, 2005, U.S. Ser. No. 11/248,717, the entirety of which is incorporated by reference herein.

### FIELD OF THE INVENTION

The invention relates generally to a connector for a tool. More particularly, the invention relates to a connector for a plasma arc system.

### BACKGROUND OF THE INVENTION

Plasma arc torches are widely used in the cutting or marking of metallic materials. A plasma torch generally includes an electrode and a nozzle having a central exit orifice mounted within a torch body, electrical connections, passages for cooling, passages for arc control fluids, and a power supply. Optionally, a swirl ring is employed to control fluid flow patterns in the plasma chamber formed between the electrode and nozzle. The torch produces a plasma arc, a constricted ionized jet of a gas with high temperature and high momentum. Gases used in the torch can be non-reactive (e.g., argon or nitrogen), or reactive (e.g., oxygen or air).

In operation, a pilot arc is first generated between the electrode (cathode) and the nozzle (anode). Generation of the pilot arc can be by means of a high frequency, high voltage signal coupled to a DC power supply and the torch or any of a variety of contact starting methods.

One known configuration of a plasma arc torch includes one or more leads connecting the torch to the power supply to provide the torch with electrical current and fluid. The engagement of the lead(s) to the power supply must be rugged to handle the stress and/or the strain placed on the lead as it is manipulated in order to place the plasma arc torch in a position to cut or mark a workpiece. The lead(s) used to connect the torch to the power supply can be a single integral lead having a fluid hose, for example, a gas hose located in the middle of the lead and electrical conductors and fillers arranged symmetrically around the gas hose. A jacket material is extruded over the gas hose, electrical conductors, and fillers. Alternatively, multiple leads attach to the power supply, for example, four fluid leads, two having cooling liquid and two having gas, attach the plasma arc torch to the power supply.

Previous connections for connecting the leads to the power supply can have any of several limitations. Some lead connections require large access areas, which impact power supply size. Certain connectors must be visible to enable engagement and/or disengagement, which impacts lead placement, space, can necessitate lighting, and can increase the time required to engage and disengage the lead connections. Other connectors require the operator to use two hands to complete the engagement and/or disengagement. Adequate space about the power supply and the leads must be available to enable two hands to access the connection. Some known connections require use of one or more tools to enable engagement and/or disengagement. The use of a tool can be time consuming, the tool can be easily misplaced, and space must be available on the power supply and/or adjacent the connector to accommodate the tool. Threaded connector fittings can be incorrectly installed and tightened causing wear and/or leaking. Certain connectors and/or leads leak after multiple or frequent engagements and disengagements.

In certain plasma arc systems, the flow of fluid through the power supply must be stopped before leads are removed. Otherwise, when a lead is removed from the power supply, fluids, for example liquid and gas, continue to flow through the power supply creating a mess, wasting fluids, and risking a slip and fall hazard. Even when the fluid flow has been stopped, liquid remaining in a removed liquid lead sometimes spills on, for example, an operator's hands or about the work area risking a safety hazard.

Similarly, previous connections for connecting the leads to the plasma arc torches can have any of several limitations. Some lead connections require large access areas, which impact plasma arc torch size and the size (e.g., the length and the diameter) of the plasma arc torch sleeve. Certain connectors must be visible to enable engagement and/or disengagement, which impacts lead placement, space, can necessitate lighting, and can increase the time required to engage and disengage the lead connections. Other connectors require the operator to use tools to complete the engagement and/or disengagement. Adequate space about the plasma arc torch, the plasma arc torch sleeve, and the leads must be available to enable hands and tools to access the connection. The use of a tool can be time consuming, the tool can be easily misplaced, and space must be available on the plasma arc torch and/or adjacent the connector to accommodate the tool. In addition, previous lead/torch connections require multiple wrench connections, which is time consuming. Threaded connector fittings can be incorrectly installed and tightened causing wear and/or leaking. Replacement of the lead set in the field is challenging and time consuming due to the limitations of these prior systems. Certain connectors and/or leads leak after multiple or frequent engagements and disengagements.

It is therefore an object of the present invention to provide an improved connection for a lead to a plasma arc torch power supply and an improved connection for a lead to a plasma arc torch.

### SUMMARY OF THE INVENTION

In one aspect, the invention relates to a power supply for a plasma arc system that includes a housing associated with the power supply. A first connector is disposed relative to the housing and is adapted to mate with a second connector along a longitudinal axis. A locking member causes, upon application of a translational force, engagement of the first connector and the second connector. Application of a linear force to the locking member at an angle relative to the longitudinal axis causes disengagement of the first connector and second connector. The linear force can be applied at an angle that ranges from about 0° to about 180°. In one embodiment, the angle is perpendicular to the longitudinal axis. The power supply can include an opening member to access the first connector, the second connector, or the first connector and the second connector.

In one embodiment, the locking member includes a planar member that is adapted to disengage the first connector and second connector upon application of a linear force applied to the planar member at an angle perpendicular to the longitudinal axis. The locking member can be integral to the first connector or, alternatively, the locking member can be integral to the second connector.

The power supply can include a third connector disposed relative to the housing that is adapted to mate with a fourth connector along a longitudinal axis. Application of a translational force to a second locking member causes engagement of the third connector and forth connector. The second locking member causes, upon application of a linear force at an angle relative to the longitudinal axis, disengagement of the third connector and the fourth connector.

The first connector can be, for example, a female connector or a male connector. In one embodiment, the first connector is a female connector and the third connector is a male connector. Optionally, the first connector defines a fluid passageway and is configured to prevent flow through the fluid passageway when the first connector is disengaged.

In another aspect, the invention relates to a lead for a plasma arc torch. The lead includes an elongated body, a first end, and a second end. A second connector is disposed on the second end of the lead and a locking member causes, upon application of a translational force along a longitudinal axis, engagement of the second connector and a first connector. As described above, applying a linear force to the locking member at an angle relative to the longitudinal axis causes disengagement of the first connector and the second connector. The locking member can include a planar member, can be integral to the first or the second connector. The second connector can be a female connector, can be a male connector, can define a fluid passageway, and/or is optionally configured to prevent flow through the fluid passageway when the second connector is disengaged.

In another aspect, the invention relates to a plasma arc torch system including a torch body, a power supply, a lead including an elongated body, a first end, and a second end. The first end is connected to the torch body. A connector assembly connects the second end of the lead with the power supply. In one embodiment, the torch body includes a nozzle mounted at a first end of the torch body. In another embodiment, an electrode is mounted at a first end of the torch body. The electrode can be in a mutually spaced relationship with the nozzle to define a plasma chamber. In another embodiment, a retaining cap is mounted on the torch body. The retaining cap can substantially enclose the outer surface of the nozzle. In another embodiment, the torch body also includes a shield having a central circular opening that is aligned with the nozzle. In another embodiment, a positive rotational restraint component is disposed on the elongated body of the lead and the second end of the lead is disposed on the power supply. The positive rotational restraint component restrains rotational movement of the lead relative to the power supply.

In another aspect, the invention relates to a method for connecting and disconnecting a torch lead to a power supply for a plasma arc torch. The method includes providing a power supply including a housing, disposing relative to the housing a first connector adapted to mate with a second connector, providing a lead including an elongated body, a first end connected to a torch body, and a second end connected to the second connector, and manipulating the first connector and the second connector relative to a locking member with one of a translational force or a linear force to engage or disengage the first connector and the second connector. In one embodiment, the method includes applying translational force to the second connector along a longitudinal axis and engaging the second connector with the first connector. In another embodiment, the method includes applying with, for example, one or more fingers a linear force to the locking member at an angle relative to a longitudinal axis and disengaging the first connector and the second connector.

In another aspect, the invention relates to a power supply for a plasma arc system that includes a housing associated with the power supply and a first connector disposed relative to the housing. The first connector defines a fluid passageway and is configured to prevent fluid flow through the fluid passageway when the first connector is disengaged from a mated second connector. In one embodiment, the first connector defines a liquid passageway and is configured to prevent flow through the liquid passageway when the first connector is disengaged from a mated second connector. In one embodiment, the first connector includes a valve adapted to open and close the fluid passageway. In another embodiment, a second connector defines a second liquid passageway and is configured to prevent flow through the second liquid passageway when the second connector is disengaged from the first connector. In another embodiment, a third connector is disposed relative to the housing and is adapted to mate with a fourth connector. The power supply can include an opening member to access the connectors and/or the connector assemblies. In one embodiment, the third connector defines a gas passageway and is, for example, configured to prevent flow through the gas passageway when the third connector is disengaged from the fourth connector. Optionally, the fourth connector defines a second gas passageway and is configured to prevent flow through the gas passageway when the third and fourth connectors are disengaged. The first connector defines a liquid passageway and the third connector defines a gas passageway. In another embodiment, a fifth connector is disposed relative to the housing. The fifth connector defines a third liquid passageway and is configured to prevent flow through the third liquid passageway when the fifth connector is disengaged from a mated sixth connector. In another embodiment, a seventh connector is disposed relative to the housing and the seventh connector defines a third gas passageway. An eighth connector is adapted to mate with the seventh connector. In one embodiment, the seventh connector defines a third gas passageway and is configured to prevent flow through the third gas passageway when the seventh connector is disengaged from the eighth connector. The eighth connector can define a fourth gas passageway and be configured to prevent flow through the fourth gas passageway when the seventh and eighth connectors are disengaged. In one embodiment, the fifth connector is a female connector and the seventh connector is a male connector.

Optionally, the connectors are designed and/or positioned to avoid incorrect engagement. In one embodiment, the first connector and second connector are both disposed on the housing and are a female and a male connector, respectively, as such connection of an incorrect mated connector disposed on, for example, a lead is avoided. In another embodiment, the first connector and the third connector are both disposed on the housing and the first connector has a first color and the third connector has a second color different from the first color. The desired lead and/or connector that mates with the first connector has a first color. Similarly, the desired lead and/or connector that mates with the second connector has a second color. Additional leads and/or connector assemblies can similarly be positioned or designed to avoid incorrect engagement. Suitable designs include, for example, color coding with the same color or complimentary colors. For example, a first connector has a light color and a second connector has a darker shade of the same color or a first connector has a solid color and a second connector features the same color, but in a design such as, for example, stripes. Alternative designs that avoid incorrect engagement include using different connector materials (e.g., plastic and metal) or using differently sized connectors and/or leads.

In another aspect, the invention relates to a lead for a plasma arc torch. The lead includes an elongated body, a first end, and a second end. A second connector is disposed on the second end of the lead. The second connector defines a fluid passageway and is configured to prevent fluid flow through the fluid passageway when the second connector is disengaged from a mated first connector. In one embodiment, the second connector includes a valve adapted to open and close the fluid passageway.

In another aspect, the invention relates to a plasma arc torch system including a torch body, a power supply and a lead. The lead includes an elongated body, a first end connected to the torch body, and a second end. A connector assembly connects the second end of the lead with the power supply. The connector assembly includes a first connector defining a fluid passageway. The first connector is configured to prevent fluid flow through the fluid passageway when the first connector is disengaged from a mated second connector.

In one embodiment, the torch body includes a nozzle mounted at a first end of the torch body. In another embodiment, the torch body includes an electrode mounted at a first end of the torch body in a mutually spaced relationship with the nozzle to define a plasma chamber. In another embodiment, a retaining cap is mounted on the torch body. The retaining cap can, for example, substantially enclose the outer surface of the nozzle. In another embodiment, a shield having a central circular opening aligned with the nozzle. In one embodiment, the lead includes a positive rotational restraint component. The positive rotational restraint component can be disposed on the elongated body and can restrain rotational movement of the lead relative to the power supply. The second end of the lead can be disposed on the power supply.

In another aspect, the invention relates to a method for connecting a torch lead to a power supply for a plasma arc torch. The method includes providing a power supply including a housing, disposing relative to the housing a first connector adapted to mate with a second connector, providing a lead including an elongated body, a first end connected to a torch body, and a second end, disposing on the second end of the lead the second connector defining a fluid passageway and configured to prevent fluid flow through the fluid passageway when the second connector is disengaged from the first connector, and engaging the first connector and the second connector. In one embodiment, the first connector defines a second fluid passageway and is configured to prevent fluid flow through the second fluid passageway when the second connector and the first connector are disengaged.

In another aspect, the invention relates to a power supply for a plasma arc system including a housing means associated with the power supply. A first connector means is disposed relative to the housing and is adapted to mate with a second connector means along a longitudinal axis. A locking means causes, upon application of a translational force, engagement of the first connector means and the second connector means. The locking means causes disengagement of the first connector means and the second connector means upon application of a linear force at an angle relative to the longitudinal axis.

In another aspect, the invention relates to a lead set for use with a plasma arc torch. The lead set includes a lead having an elongated body, a first end, and a second end. A first connector is disposed on the first end of the lead. The first connector is capable of engaging a second connector by causing a compression force in a second connector upon application of a translational force along a longitudinal axis of the lead. In one embodiment, the second connector is located separate from the lead set, for example, the second connector is disposed on a plasma arc torch member or on a power supply. The second connector can, upon application of a depression force along the longitudinal axis, cause disengagement of the first connector.

In one embodiment, the second connector has a deformable member that is adapted to disengage the first connector and the second connector upon application of a depression force applied along the longitudinal axis to the second connector. Optionally, during application of the depression force to the second connector, the deformable member is adapted to disengage the first connector and the second connector upon application of a linear force applied along the longitudinal axis to at least one of the first connector and a second connector. In one embodiment, a depression force is applied to the second connector and a linear force is applied to the first connector in a direction opposite to the depression force.

In one embodiment, the lead includes a third connector disposed on the second end of the lead. The third connector is capable of engaging a fourth connector via a locking member upon application of a translational force along a second longitudinal axis of the lead. The locking member causes, upon application of a linear force at an angle relative to the second longitudinal axis, disengagement of the third connector. Suitable locking members include, for example, a planar member adapted to disengage the third connector upon application of a linear force applied to the planar member at an angle perpendicular to the second longitudinal axis.

In yet another embodiment, a third connector, disposed on the second end of the lead, is capable of engaging a fourth connector by causing a compression force in the fourth connector upon application of a translational force along a second longitudinal axis of the lead. The fourth connector causes, upon application of a depression force along the second longitudinal axis, disengagement of the third connector. In one embodiment, the second connector has a first deformable member adapted to disengage the first connector upon application of a depression force applied along the first longitudinal axis to the second connector and the fourth connector has a second deformable member adapted to disengage the third connector upon application of a depression force applied along the second longitudinal axis to the fourth connector. In one embodiment, during application of the depression force to the second and the fourth connectors, the first deformable member is adapted to disengage the first connector and the second connector upon application of a linear force applied along the longitudinal axis to at least one of the first connector and a second connector and a second deformable member is adapted to disengage the third connector and a fourth connector upon application of a second linear force applied along the second longitudinal axis to at least one of the third connector and a fourth connector. Optionally, at least one of the first connector and a second connector defines a fluid passageway and is configured to prevent flow through the fluid passageway when disengaged.

In another embodiment, a second lead has an elongated body, a first end, and a second end and a third connector is disposed on the second lead first end. The third connector is capable of engaging a fourth connector by causing a compression force in the fourth connector upon application of a translational force along a second longitudinal axis of the second lead. The fourth connector causing, upon application of a depression force to the fourth connector along the second longitudinal axis, disengagement of the third connector.

In one embodiment, the first connector has a first feature and the third connector has a second feature. Optionally, the first feature is different from the second feature. The first feature and the second feature are one or more of color, size, material, weight, gender, and conductivity, for example. In an exemplary lead set, the first connector is a male connector and the third connector is a female connector. Leads and/or connectors can be given design features, for example, they can be sized, colored, or positioned to ensure connection of mated connectors and avoid incorrect engagement of the lead to the torch and/or the power supply. For example, the one or more of first connector, second connector, third connector, fourth connector, and lead can be colored the same color to indicate its mated connector and or the suitable connection point for a lead. In another embodiment, the leads and/or the connector assemblies are designed to avoid incorrectly engaging the leads with, for example, the wrong connector assembly or with an incorrect fluid source. For example, leads that transport gases, liquids, and power can be sized and/or colored or given other design features that indicate what they transport. Other design features that avoid incorrect engagement include, for example, varying materials, textures, size of connector assemblies, and other design options known to the skilled person. Optionally, keys and/or keysets can be employed on the leads and/or on the connectors to avoid incorrect engagement. The number of connector assemblies, the position of one or more connector assembly on the housing associated with the power supply, the type and/or design of connector assembly, and the type of fluid flowing through each lead connected by each connector assembly will be selected in accordance with the specific plasma torch member and/or power supply.

In still another embodiment, the lead set has a plurality of additional leads each additional lead having a first end, a second end, and a body. A first connector disposed on each first end is capable of engaging a second connector by causing a compression force in a second connector upon application of a translational force along a longitudinal axis of each lead. The second connector causes, upon application of a depression force to the second connector along the longitudinal axis, disengagement of the first connector.

In another aspect, the invention relates to a plasma arc torch system including a plasma arc torch member, a lead including an elongated body, a first end, and a second end. A second connector is disposed relative to the torch member. A first connector is disposed on the first end of the lead. The first connector engages the second connector by causing a compression force in the second connector upon application of a translational force along a longitudinal axis of the lead. In one embodiment, the second connector causes, upon application of a depression force to the second connector along the longitudinal axis, disengagement of the first connector.

The plasma arc torch system can include a power supply. A fourth connector is disposed on the power supply and a third connector, disposed on the second end of the lead, is adapted to mate with the fourth connector along a second longitudinal axis. In one embodiment, a locking member causes, upon application of a translational force, engagement of the third connector and the fourth connector. The locking member causes, upon application of a linear force at an angle relative to the second longitudinal axis, disengagement of the third connector and the fourth connector. In another embodiment, the third connector engages the fourth connector by causing a compression force in the fourth connector upon application of a translational force along the second longitudinal axis. The fourth connector causes, upon application of a depression force to the fourth connector along the second longitudinal axis, disengagement of the third connector.

In one embodiment, a nozzle is mounted at the first end of the torch member and an electrode is mounted at the first end of the torch member in a mutually spaced relationship with the nozzle to define a plasma chamber. A retaining cap mounted on the torch member substantially encloses the outer surface of the nozzle. A shield having a central circular opening is aligned with the nozzle. The plasma arc torch member can have a plasma arc torch and a coupler. In one embodiment, the second connector is disposed on the coupler.

In another aspect, the method for connecting and disconnecting a lead to a plasma arc torch includes manipulating a first connector disposed on a first end of the lead relative to a second connector coupled to the plasma arc torch, by performing at least one of (1) applying to the first connector a translational force along a longitudinal axis of the lead causing a compression force in the second connector that engages the first connector and the second connector or (2) applying to the second connector a depression force along the longitudinal axis that disengages the first connector and the second connector. One embodiment of the method also includes, applying a depression force to the second connector and simultaneously or subsequently applying a linear force along the longitudinal axis to at least one of the first connector and the second connector and disengaging the first connector and the second connector. In one embodiment of the method, the first connector defines a fluid passageway and is configured to prevent flow through the fluid passageway when the first connector is disengaged, alternatively or in addition, the second connector defines a fluid passageway and is configured to prevent flow through the fluid passageway when the second connector is disengaged.

The method can also include disposing, relative to a power supply comprising a housing, a fourth connector adapted to mate with a third connector disposed on the second end of the lead. In one embodiment, the third connector is manipulated relative to the fourth connector with one of a translational force or a depression force to engage or disengage the third connector and the fourth connector. In another embodiment, the third connector and the fourth connector are manipulated relative to a locking member with one of a translational force or a linear force to engage or disengage the third connector and the fourth connector.

The connectors and/or connector assemblies can be engaged and/or disengaged with or without tools. In a tool-free method of connection, the connectors can be engaged or disengaged with one or more of a user's fingers. Because the connectors and the connector assemblies can be engaged and/or disengaged with a user's hands, they are easy to use. The area around the connection assembly does not need to accommodate tools or the range of motion required by tools; rather, the area surrounding the connection assembly must accommodate one or more fingers of an operator. The placement of the connectors and/or connector assembly on the plasma arc torch and/or the power supply is accordingly more flexible than when tools are required. Thus, the lead set saves both time required to engage and/or disengage the connection assembly and reduces and/or eliminates the tools required to perform connection and disconnection tasks as compared to a connection requiring tools. Thus, the connection assembly reduces the time required for, for example, assembly, repair, changing lead size, and changing lead type. In addition, because the number of tools required to engage and/or disengage the connection assembly is reduced and/or eliminated the installation, repair, and change complexity are also reduced. The tool free method avoids over tightened and/or under tightened connections thereby reducing leakage, about the connection assembly, of what is being transported through the leads. Also, the life of the connection assembly is improved. In some embodiments, the connectors and/or the connector assembly are designed for frequent and multiple engagements and disengagements.

### BRIEF DESCRIPTION OF THE DRAWINGS

FIG. 1 illustrates a connector assembly including a first connector adapted to mate with a second connector along a longitudinal axis.

FIG. 2A illustrates a first connector.

FIG. 2B illustrates a second connector adapted to mate with the first connector of FIG. 2A.

FIG. 3A illustrates a cross section of a first connector illustrated in FIG. 2A adapted to mate along a longitudinal axis with a second connector illustrated in FIG. 2B.

FIG. 3B illustrates a cross section of the first connector illustrated in FIG. 2A engaged with a second connector illustrated in FIG. 2B.

FIG. 4A illustrates a disengaged locking member.

FIG. 4B illustrates an engaged locking member.

FIG. 5A illustrates another embodiment of a connector assembly including a first connector adapted to mate with a second connector along a longitudinal axis.

FIG. 5B illustrates a connector having a raised button.

FIG. 6A is a diagram of multiple leads attached by a connector assembly to a plasma arc torch power supply and a single lead detached from the plasma arc torch power supply.

FIG. 6B is another diagram of multiple leads attached to a plasma arc torch power supply and a single lead detached from the plasma arc torch power supply, a connector disposed on each lead has a mated connector disposed on the power supply.

FIG. 7 illustrates a strain relief system.

FIG. 8 is a diagram of a plasma arc torch power supply, lead, a connector, a strain relief system and a torch body used for cutting or piercing a metal workpiece.

FIG. 9 is a schematic cross-sectional view of a conventional plasma arc torch.

FIG. 10A illustrates a first connector.

FIG. 10B illustrates a second connector adapted to mate with the first connector of FIG. 10A.

FIG. 10C illustrates a connector assembly including a first connector engaged with a second connector along a longitudinal axis.

FIG. 10D illustrates a connector assembly including a first connector becoming disengaged from a second connector along a longitudinal axis.

FIG. 10E illustrates a lead having an elongated body with a first connector disposed on a first end and a third connector disposed on a second end.

FIG. 11A illustrates a plurality of leads on the first end of each lead is disposed a first connector capable of engaging a second connector and a plurality of second connectors are disposed on a plasma arc torch member.

FIG. 11B illustrates a plurality of leads on the first end of each lead is disposed a first connector capable of engaging a second connector and a plurality of second connectors are disposed on the coupler within a plasma arc torch member.

FIG. 11C illustrates a plurality of leads held within a sleeve and within a strain relief system on the first end of each lead is disposed a first connector capable of engaging a second connector and a plurality of second connectors are disposed on the coupler within a plasma arc torch member.

FIG. 12 is a diagram of a plasma arc torch power supply, a plasma arc torch body used for cutting or piercing a metal workpiece, a lead, a connection assembly that connects the lead to the power supply, and a connection assembly that connects the lead to the plasma arc torch body.

FIG. 13 is a schematic diagram of plasma arc torch system for automatically cutting a metallic work piece.

### DETAILED DESCRIPTION OF THE INVENTION

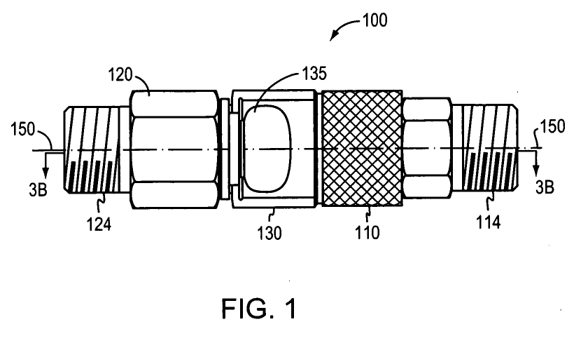

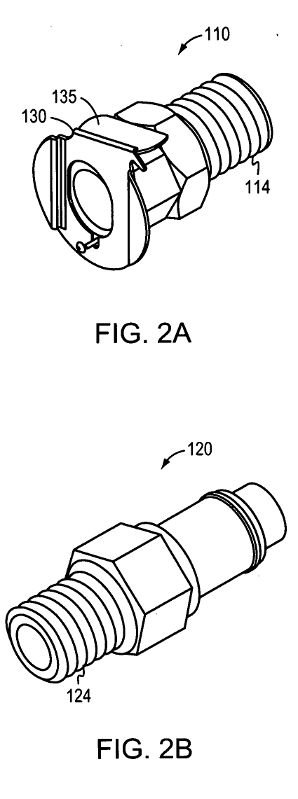

FIG. 1 illustrates a connector assembly 100 that connects a lead to a power supply for a plasma arc system. Referring also to FIGS. 2A-2B, the connector assembly 100 features a first connector 110 and a second connector 120. The first connector 110 is adapted to mate with the second connector 120 along a longitudinal axis 150. The first connector 110 is, for example, a female connector adapted to receive a mated male connector. A first locking member 130 engages the first connector 110 and the mated second connector 120. Similarly, the first locking member 130 disengages the first connector 110 and the second connector 120. In one embodiment, the first locking member 130 is integral to the first connector 110. Alternatively, a locking member can be integral to the second connector 120 (not shown). In another embodiment, a locking member is separate from both the first connector 110 and the second connector 120 (not shown).

The first connector 110 termination 114 is threaded and the second connector 120 termination 124 is also threaded. Other suitable terminations for the connectors and/or the connector assemblies can be in line, in line hose, elbow, barbed terminations, or any other termination suitable for an application employing the connector and/or the connector assembly. Optionally, the terminations 114, 124 are integral to the connectors 110, 120. Alternatively, the terminations 114, 124 are separate from and assemble or join with the connectors 110, 120. Each of the terminations for a connector assembly 100 can be the same, for example, the terminations 114 and 124 are each threaded terminations. Alternatively, one termination 114 is different from another termination 124 on a single connector assembly 110 (not shown), for example, one termination on a connector assembly is threaded and the other termination is in line.

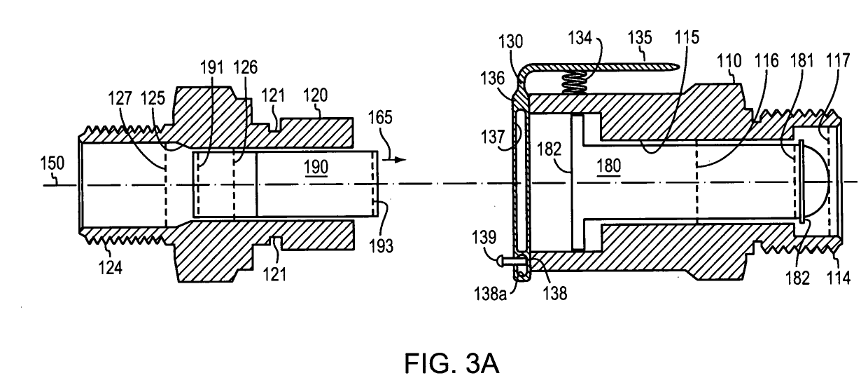

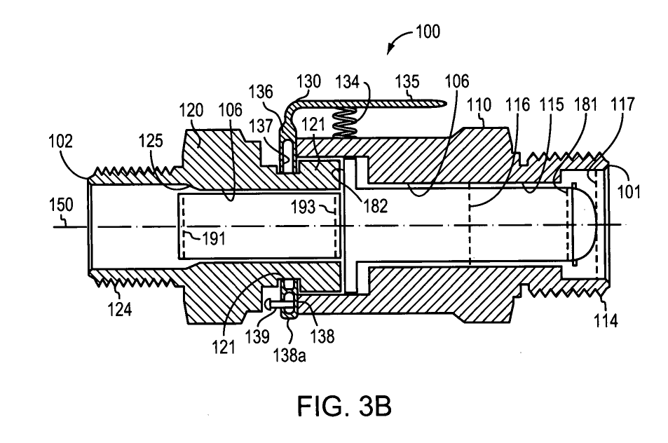

FIG. 3A illustrates a cross section of the first connector 110, the second connector 120, and the first locking member 130. In this illustrative embodiment, the first locking member 130 is integral to the first connector 110. The first connector 110 defines a first fluid passageway 115 and the second connector 120 defines a second fluid passageway 125. A translational force 165 is applied, along the longitudinal axis 150, to the first locking member 130 by the second connector 120. The translational force 165 applied to the first locking member 130 causes engagement of the first connector 110 and the second connector 120. Upon engagement of the first connector 110 and the second connector 120 a connector assembly 100 is formed. FIG. 3B illustrates a cross section of the connector assembly 100. When the connector assembly 100 is formed, the first fluid passageway 115 and the second fluid passageway 125 join to provide a fluid passageway 106 through connector assembly 100. Fluid flows through the connector assembly fluid passageway 106, between the first end 101 and the second end 102. Fluid can flow in either direction, e.g., from the first end 101 toward the second end 102 or, alternatively, from the second end 102 toward the first end 101.

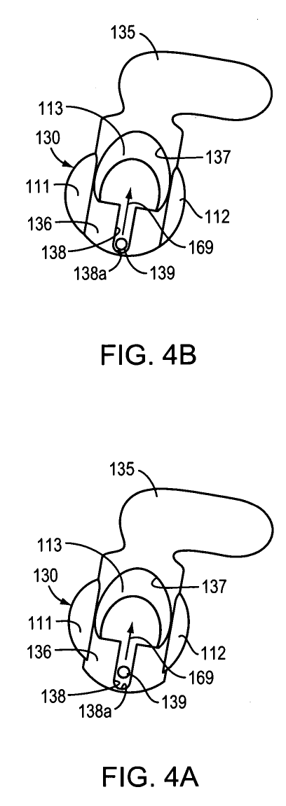

FIG. 4A illustrates an embodiment of a first locking member 130 in the disengaged position and FIG. 4B illustrates an embodiment of a first locking member 130 in the engaged position. The first locking member 130 features a touch position 135, a planar member 136 defining an ellipse 137, optionally, featuring a cleft 138 that splits at least a portion of the ellipse 137. In one embodiment, the first locking member 130 features a leg 139 that retracts and extends.

Referring now to FIGS. 3A-3B and 4A-4B, in one embodiment, the first locking member 130 is integral to the first connector 110. The planar member 136 is adjacent the face of first end 113 of the first connector 110. The planar member 136 is positioned between the face of the first end 113 and a first support 111 and a second support 112. The first and second supports 111, 112 are adapted to moveably support the planar member 136 such that it is held adjacent the first connector 110. In one embodiment, a portion of the face of the first end 113 of the first connector 110 is visible through the ellipse 137 defined in the planar member 136. FIGS. 3A and 4A illustrate the disengaged first locking member 130. In the disengaged position the leg 139 extends relative to the face of the first end 113. The bottom portion 138a of cleft 138 falls below the leg 139.

FIGS. 3B and 4B illustrate the engaged first locking member. The translational force 165 applied to the first locking member 130 causes retraction of the leg 139. The planar member 136 moves in direction 169 and the bottom portion 138a of cleft 138 moves adjacent to and touches leg 139. At least a portion of the ellipse 137, defined within the planar member 136, moves inside at least a portion of groove 121. Groove 121 is disposed about at least a portion of the surface of the second connector 120. The portion of the ellipse 137 disposed inside the portion of groove 121 engages the first connector 110 and the second connector 120 forming the connector assembly 100.

Referring now to FIGS. 3A-3B, the first connector 110 defines a fluid passageway 115 and is optionally configured to prevent fluid flow through the fluid passageway 115 when the first connector 110 is not engaged. In one embodiment, referring now to FIG. 3A, when the first connector 110 is not engaged a valve 180 obstructs the flow of fluid through the fluid passageway 115. At least a portion of the valve 180 prevents the flow of fluid through a first diameter 116 of the fluid passageway 115 of an unengaged first connector 110. For example, the first end 181 (e.g., the diameter of the first end portion 181) of the valve 180 is sized to prevent the flow of fluid through the first diameter 116 when the first connector 110 is unengaged. Referring again to FIGS. 3A and 3B, when the first connector 110 is engaged with a second connector 120 the second connector 120 moves the valve 180 to enable fluid to flow through the fluid passageway 115. For example, the first end 181 of the valve is pushed out of the first diameter 116 and into a second diameter 117, a larger diameter, thereby unblocking the first diameter 116 of the fluid passageway 115 to enable fluid to flow through fluid passageway 115.

In another embodiment, the valve 180 features an o-ring 182 that is sized to prevent fluid from flowing through the first diameter 116 of the fluid passageway 115 of an unengaged first connector 110. When the first connector 110 and the second connector 120 engage, the second connector 120 moves the valve 180. The o-ring 182 disposed on the valve 180 moves into the second diameter 117, a larger diameter, and this movement unblocks the first diameter 116 enabling fluid to flow through the first diameter 116 of the fluid passageway 115. A valve 180 can be adapted to obstruct the flow of fluid through the fluid passageway 115 by any of a variety of configurations known to the skilled person.

The second connector 120 defines a fluid passageway 125 and is optionally configured to prevent fluid flow through the fluid passageway 125 when the second connector 120 is not engaged. In one embodiment, referring now to FIG. 3A, when the second connector 120 is not engaged a valve 190 obstructs the flow of fluid through the fluid passageway 125. The valve 190 has a first end 191 and a second end 193. At least a portion of the valve 190 prevents the flow of fluid through a first diameter 126 of the fluid passageway 125. In one embodiment, the first end 191 (e.g., the diameter of the first end portion 191) of the valve 190 is sized to prevent the flow of fluid through the first diameter 126 of the fluid passageway 125 of an unengaged second connector 120. Referring again to FIGS. 3A and 3B, when the second connector 120 is engaged with a first connector 110, the first connector 110 moves the valve 190 to enable fluid to flow through the fluid passageway 125. For example, the first end 191 of the valve 190 is pushed out of the first diameter 126 and into a second diameter 127, a larger diameter. The first diameter 126 of the fluid passageway 125 is unblocked and fluid is able to flow through the first fluid passageway. In another embodiment, the valve 190 can optionally feature an o-ring (not shown) that is sized to prevent fluid from flowing through the fluid passageway 125 of an unengaged second connector 120. Upon engagement, the first connector 110 moves the valve 190 and the o-ring disposed on the valve 190 thereby unblocking the fluid passageway 125 at, for example, the first diameter 126, enabling fluid to flow therethrough. A valve 190 can be adapted to obstruct the flow of fluid through the fluid passageway 125 by any of a variety of configurations known to the skilled person.

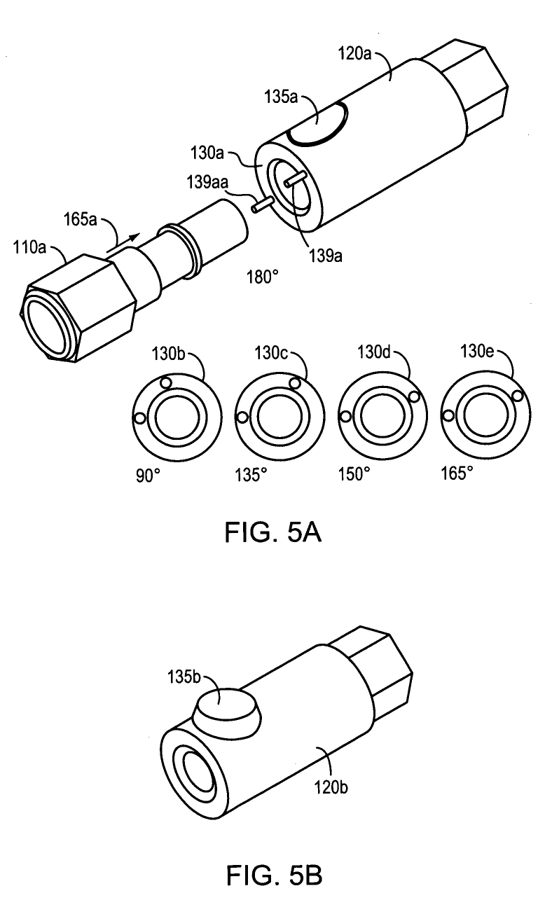

FIG. 5A illustrates another embodiment of a first connector 110a, a second connector 120a, and a locking member 130a integral to the second connector 120a. A translational force 165a applied to the locking member 130a by the first connector 110a engages the first connector 110a and the second connector 120a forming a connector assembly. In one embodiment, the touch position 135a comprises a safety button that is at a level flush with the locking member 130a and/or the second connector 120a. In another embodiment, referring also to FIG. 56B, the touch position 135b comprises a raised button positioned at a level elevated from the second connector 120b. The first connector 110a, the second connector 120a, and/or the locking member 130a can be positioned and/or designed to avoid incorrect engagement between various fluids, connectors, and/or leads. For example, the one or more of first connector 110a, the second connector 120a, and/or the locking member 130a can be colored to indicate its mated connector and/or locking member. One or more locking member, for example, 130a, 130b, 130c, 130d, and 130e can be designed to only engage with a mated connector. For example, each of two or more legs 139a, 139aa of locking member 130a are separated by, for example, 180° about the face of the locking member. The legs 139a and 139aa can be separated by between about 5° and about 180°, by between about 90° and about 165°, or by between about 135° and about 150°.

Suitable first connectors, second connectors, locking members, and/or connector assemblies are disengaged with a single touch, by for example, pressing or touching the touch position (e.g., 135, 135a, 135b) on the connector, locking member, and/or the connector assembly. A connector assembly can have one or more touch position. The first connector and second connector can be engaged by one or more fingers on a single hand that, for example, grasps the second connector and applies a translational force to the locking member. The locking member can be integral to the mated first member. The translational force is applied along a longitudinal axis through the first connector and the mated second connector. The first connector and the second connector can be disengaged by one or more fingers on a single hand that press the touch position and apply a linear force to the touch position at an angle relative to a longitudinal axis along the mated first and second connector. Tools can optionally be used to disengage, however, tools are not required to disengage the connector, locking member, and/or the connector assembly. Accordingly, the power supply and the housing associated with the power supply can be sized and arranged without requiring space for tools to fit and have a necessary range of motion. Rather, the size and arrangement of the power supply accommodates an operator hand to disengage a connector, a locking member, and/or a connector assembly. The placement of the connector, locking member, and/or connector assembly on the power supply is accordingly more flexible then when the connector, locking member, and/or connector assembly requires tools. For example, one or more operator fingers can be used to disengage the connector. Accordingly, the line 105 can be detached from the power supply with a single hand or one or more fingers when using a connector, a locking member, and/or a connector assembly of the present invention. Thus, the power supply and/or the associated housing requires less access space then connectors, locking members, and connector assemblies requiring tools for disengagement. In some embodiments, the connector, the locking member, and/or the connector assembly are designed for frequent and multiple engagements and disengagements. The connector(s), locking members, and/or connector assembly employed in accordance with the present invention require less time for disengagement when compared with disengagements requiring tools. For example, an operator using tools disengaged four lines with threaded connectors from a power supply in two minutes. The same operator using one or more fingers on a single hand disengaged four lines having a touch position from a power supply in thirty seconds. Accordingly, the connectors of the invention provided a four fold improvement in the time required to disengage for lead connectors from a power supply.

Suitable connectors, locking members, and/or connector assemblies that can be used in accordance with the present invention are available from, for example, Colder Products Company (St. Paul, Minn.), Stäubli Corporation (Duncan, S.C.), and Parker Quick Coupling Division (Minneapolis, Minn.). Exemplary connectors and connector assemblies available from Colder Products Company include LC Series, NS4 Series, PMC Series, PLC Series, and MC Series. Suitable connectors and connector assemblies available from Stäubli Corporation include RBE and RBE03 quick release couplings. Suitable connectors and connector assemblies available from Parker's Quick Coupling Division include Hydraulic Quick Couplings.

The connector, locking member, and/or the connector assembly made be made from any suitable materials including, for example, metals (e.g., brass, chrome plated brass, stainless steel, and chrome), plastics (e.g., acetal), a combination of metals and polymers, metal and copolymers, and metal and polymer composites.

A LC Series connector assembly sourced from Colder Products Company was employed with a plasma arc torch system. Specifically, a first connector was disposed on a first end of a lead and a second connector was disposed relative to a power supply. The first connector and second connector mate along a longitudinal axis and upon application of a translational force form the LC Series connector assembly. The lead and connector assembly were tested by being pulled under a 100 lb axial load (“the 100 lb axial pull test”). During and subsequent to the 100 lb axial pull test, the connector assembly remained engaged and did not release. No lead leakage was observed during or subsequent to the 100 lb axial pull test.

In one embodiment, the first connector, second connector, locking member, and/or the connector assembly are configured to prevent fluid flow through a fluid passageway when not engaged. A valve, for example, or other device can be employed to obstruct the flow of fluid through the fluid passageway. The valve or other device can be made of any suitable materials, for example, metals (e.g., brass, chrome plated brass, stainless steel, and chrome), polymers (e.g., acetal), a combination of metals and polymers, and metal and polymer composites.

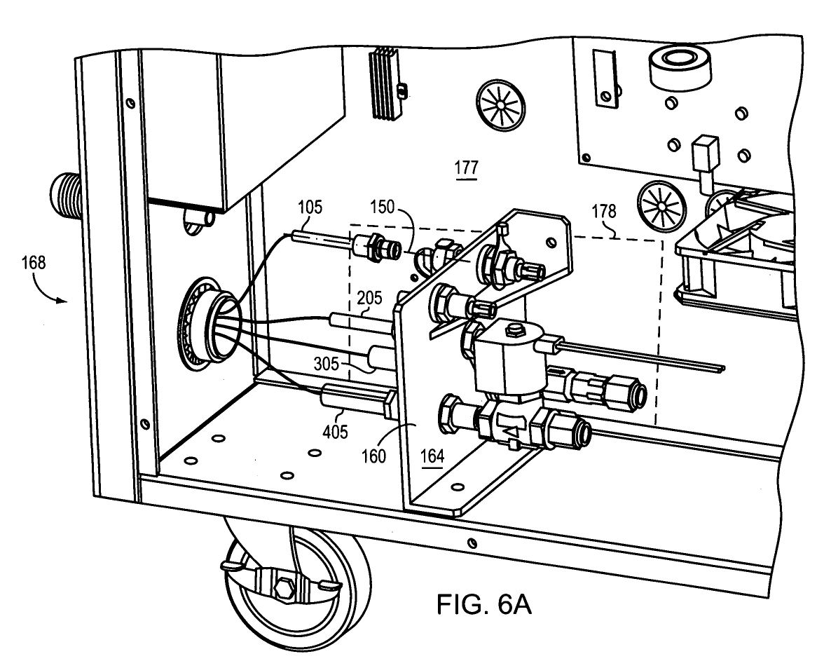

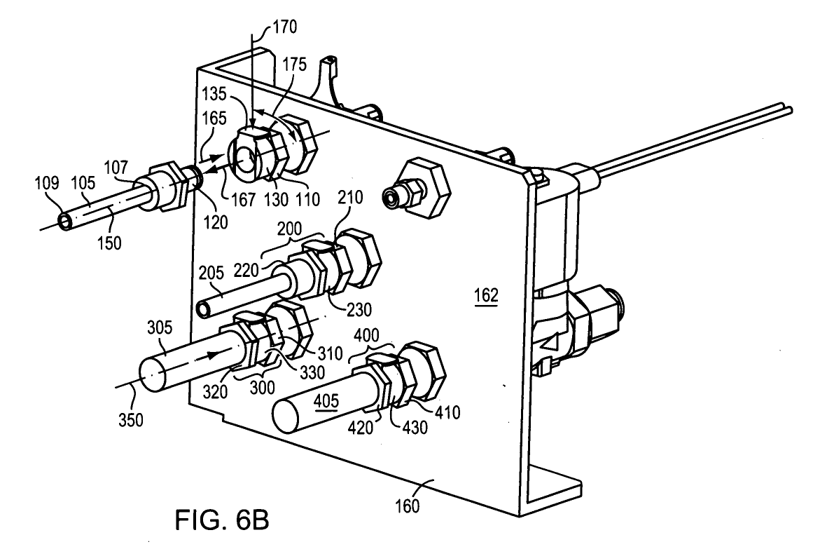

FIGS. 6A-6B illustrate an embodiment where a first lead 105 is disconnected from the housing 160 associated with a power supply 168 and three leads 205, 305, and 405 are connected to the housing 160. In one embodiment, the housing 160 is adjacent the power supply 168. The housing 160 is made from, for example, a non-conducting material (e.g., polymer or plastic), conducting material (e.g., metal), or a combination of non-conducting and conducting materials. A combination of a non-conducting and conducting materials includes, for example, two or more layers of metal and plastic or a panel of metal adjacent a panel of plastic. In one embodiment, the housing 160 is a non-conducting bulkhead. In one embodiment, the housing 160 is a member. In another embodiment (not shown), the connector is disposed relative to a power supply 168 housing. In other embodiments, leads and/or connectors that conduct electricity are connected to a non-conducting housing 160 or to a portion of a housing 160 that is non-conducting.

The power supply 168 housing 160 is provided and the first connector 110 is disposed relative to housing 160 and is adapted to mate, along the longitudinal axis 150, with a second connector 120. In one embodiment, the first connector 110 is disposed on the housing 160. In one embodiment, the first connector 110 is a female connector adapted to mate with a male second connector 120. The female first connector 110 is disposed on the front 162 of the housing 160.

The lead 105 features an elongated body, a first end 107 and a second end 109 opposite the first end 107. The first connector 110 is disposed on the housing 160 and the second connector 120 is disposed on a first end 107 of the first lead 105. Optionally, a torch body (not shown) is disposed on a second end 109 of the lead 105. The second connector 120 is adapted to mate with the first connector 110. In one embodiment, the first locking member 130 is integral to or integrated with the first connector 110. The first connector 110 and the second connector 120 are manipulated relative to the locking member 130 with one of a translational force or a linear force to engage or disengage the first connector 110 and the second connector 120.

Referring now to FIGS. 3A-3B and 6B, in one embodiment, a translational force 165 is applied, along the longitudinal axis 150, to the first locking member 130 by the second connector 120. The translational force 165 applied to the first locking member 130 causes engagement of the first connector 110 and the mated second connector 120. Referring to FIG. 3B, the engaged first connector 110 and second connector 120 form the connector assembly 100. Referring now to FIGS. 3A-3B and 4A-4B, in one embodiment, upon application of the translational force 165 to the first locking member 130 at least a portion of the ellipse 137 disposed inside the portion of groove 121 engages the first connector 110 and the second connector 120. Optionally, a leg 139 retracts when the first connector 110 and the second connector 120 engage.

The first locking member 130 can disengage the first connector 110 and the second connector 120. Referring now to FIGS. 4A and 6B, in one embodiment, a linear force 170 is applied to the first locking member 130 at an angle 175 relative to the longitudinal axis 150. The application of the linear force 170 at the angle 175 causes disengagement of the first connector 110 and the second connector 120. Referring also to FIG. 4A, in one embodiment, upon application of a linear force 170 to a touch position 135 the planar member 136 is moved and the ellipse 137 and the groove 121 are disengaged. Optionally, the linear force 170 is applied to the touch position by one or more fingers or, for example, a operator's hand.

In one embodiment, the angle 175 ranges from about 0° to about 180° relative to the longitudinal axis 150. In another embodiment, the angle 175 ranges from about 45° to about 135° relative to the longitudinal axis 150. In still another embodiment, the angle 175 measures about 90° relative to the longitudinal axis 150. In another embodiment, the angle 175 is perpendicular to the longitudinal axis 150.

Referring again to FIGS. 6A-6B, a third connector 210 is disposed relative to the housing 160 and is adapted to mate with the fourth connector 220. For example, the third connector 210 is disposed on the housing 160. A second locking member 230 engages the third connector 210 and the fourth connector 220 forming a second connector assembly 200. The fourth connector 220 is disposed on an end of the second lead 205 and the second connector assembly 200 connects the second lead 205 to the housing 160 associated with the power supply 168. In one embodiment, a translational force applied to the second locking member 230 by the fourth connector 220 engages the third connector 210 and the fourth connector 220. A connector disposed on the housing is optionally a male connector adapted to fit inside of a mated female connector disposed on an end of a lead.

A fifth connector 310 is disposed relative to the housing 160 and is adapted to mate with the sixth connector 320. In one embodiment, the fifth connector 210 is disposed on the housing. A third locking member 330 engages the fifth connector 310 and the sixth connector 320, forming a third connector assembly 300. The sixth connector 320 is disposed on an end of the third lead 305 and the third connector assembly 300 connects the third lead 305 to the housing 160. In one embodiment, a translational force applied to the third locking member 330 by the fifth connector 310 engages the fifth connector 310 and the sixth connector 320.

A seventh connector 410 is disposed on the housing 160 and is adapted to mate with the eighth connector 420. The fourth locking member 430 engages the seventh connector 410 and the eighth connector 420, forming a fourth connector assembly 400. The eighth connector 420 is disposed on an end of the fourth lead 405 and the fourth connector assembly 400 connects the fourth lead 405 to the housing 160 associated with the power supply 168. A translational force applied to the fourth locking member 430 engages the seventh connector 410 and the eighth connector 420.

Referring now to FIG. 6B, in one embodiment, the linear force 170 is applied to the touch position 135 on the first locking member 130. The linear force 170 applied to the touch position 135 is applied at an angle 175 relative to the longitudinal axis 150. The first connector 110 and the second connector 120 disengage upon application of the linear force 170 applied to the touch position. Referring also to FIGS. 3A-3B, and 4A-4B, as a result of the force 170 applied to the touch position 135, the at least a portion of the ellipse 137 is separated from the groove 121 disposed about the second connector 120 thereby disengaging the connector assembly 100 formed by the first connector 110 and the second connector 120. Optionally, a leg 139 extends from the first locking member 130 and pushes the second connector 120 away from the first locking member 130. Referring again to FIGS. 6A-6B, in an exemplary embodiment, locking members 130, 230, 330, 430 each feature a touch position that, upon application of a linear force applied at an angle relative to the longitudinal axis of the respective connector assembly 100, 200, 300, 400 disengages the connector assembly.

One or more of the connectors each defines a fluid passageway and is optionally configured to prevent fluid flow through the fluid passageway when the connector is not engaged. Suitable fluids that can flow through the fluid passageways include, for example, liquids and gases. In one embodiment, the third connector 210 mounted on or associated with the power supply is configured to prevent fluid flow through its fluid passageway when the connector 210 is not engaged. This prevents fluid from continuing to be supplied when the third connector 210 is not connected to its mated fourth connector 220, avoiding fluid waste, dirtying the work area, and risking a hazardous work area. In one embodiment, the mated fourth connector 220 has a fluid passageway that allows fluid to flow when the fourth connector 220 is not engaged. Alternatively, the third connector 210 and the mated fourth connector 220 are each configured to prevent fluid flow through their fluid passageways when the connectors 210 and 220 are not engaged. A fourth connector 220 configured to prevent fluid flow through its passageway avoids fluid remaining in a removed lead 205 from exiting the lead 205. Optionally, the power supply 168 has a shut off valve that stops the flow of fluids through the power supply. The shut off valve can be manually actuated by, for example, the operator. Alternatively, the shut off valve can be automatically actuated according to feedback from the plasma arc torch.

Referring still to FIGS. 6A-6B, in one embodiment both gas and liquid flow through the leads. For example, gas flows through the first connector assembly 100 and through the first lead 105, gas flows through the second connector assembly 200 and through the second lead 205, liquid flows through the third connector assembly 300 and through the third lead 305, and liquid also flows through the fourth connector assembly 400 and through the fourth lead 405. For example, the liquid flowing through the fourth connector assembly 400 and through the fourth lead 405 is directed from the power supply 168 toward the fourth lead 405 and the liquid flowing through the third lead 305 and through the third connector assembly 300 is directed from the third lead 305 toward the power supply 168. The liquid can be, for example, a coolant supplied from the power supply 168 to a cool a torch through the fourth lead 405 and the coolant returns from the torch to the power supply 168 through the third lead 305. For example, air is supplied from the power supply 168 to the torch through the second lead 205 and nitrogen is supplied from the power supply 168 to the torch through the first lead 105.

In another embodiment, the leads and/or the connector assemblies are designed to avoid incorrectly engaging the leads with, for example, the wrong connector assembly or with an incorrect fluid source. Leads and/or connectors can be sized, colored, or positioned to avoid incorrect engagement. For example, leads that transport gases can be sized differently then leads that transport liquids. Additionally, leads that supply coolant liquid from the power supply can be sized differently then leads that return coolant liquid to the power supply. Leads that supply one fluid can be a first size and leads that supply another fluid are a second size. Optionally, leads are color coded to indicate the fluid they transport. Connectors can similarly be color coded to indicate their mated connector and/or the fluid that they transport. Alternatively, or in addition, the mated connectors that form a connector assembly can be designed or positioned to avoid incorrect engagement. For example, in an embodiment where the third lead 305 and the fourth lead 405 transport coolant, the fifth connector 310, which is disposed on the front 162 of housing 160, is a female connector and the seventh connector 410, also disposed on the front 162 of housing 160, is a male connector. The complimentary sixth connector 320 avoids incorrect engagement because it is a male connector that is unable to mate with the seventh connector 410, also a male connector. Other design options that avoid incorrect engagement include, for example, varying materials, textures, size of connector assemblies, and other design options known to the skilled person. Optionally, keys and/or keysets can be employed to avoid incorrect engagement. The number of connector assemblies, the position of one or more connector assembly on the housing associated with the power supply, the type and/or design of connector assembly, and the type of fluid flowing through each lead connected by each connector assembly will be selected in accordance with the specific power supply.

Optionally, the leads provide an electrical conduit from the power supply to the plasma arc torch. For example, the connectors and the lead each contain a conductive material that carries electrical power at high D. C. current levels, at high voltages and/or high frequencies. Suitable conductive materials include, for example, metals, metal polymer combinations, and metal polymer composites. Suitable conductive connector and lead materials and designs that can be employed in accordance with the instant invention are disclosed in U.S. Pat. No. 5,074,802 to Gratziani et al. entitled Pneumatic-Electric Quick Disconnect Connector for a Plasma Arc Torch, which is incorporated by reference herein.

In another embodiment, a mechanized power supply features only a single lead. Suitable leads can be made from various materials such as, for example, metals (e.g., brass, chrome plated brass, stainless steel, and chrome), polymers (e.g., acetal), a combination of metals and polymers, a combination of metals and copolymers, and metal and polymer composites.

In one embodiment, referring again to FIGS. 6A and 8, the power supply 168, 168a housing features an opening member 178, 178a. The opening member 178, 178a enables access one or more connector and/or connector assembly located on the power supply 168, 168a housing. Optionally, the opening member 178, 178a enables access to the inside of the power supply 168, 168a without removing a portion of a cover 177, 177a from the power supply 168, 168a housing. In one embodiment, the opening member is a door that enables access to one or more connector and/or connector assembly. Alternatively, at least a portion of a cover 177, 177a of the power supply 168, 168a housing is removed by, for example, removing screws or other suitable fasteners that secure the cover 177, 177a to the power supply 168, 168a housing.

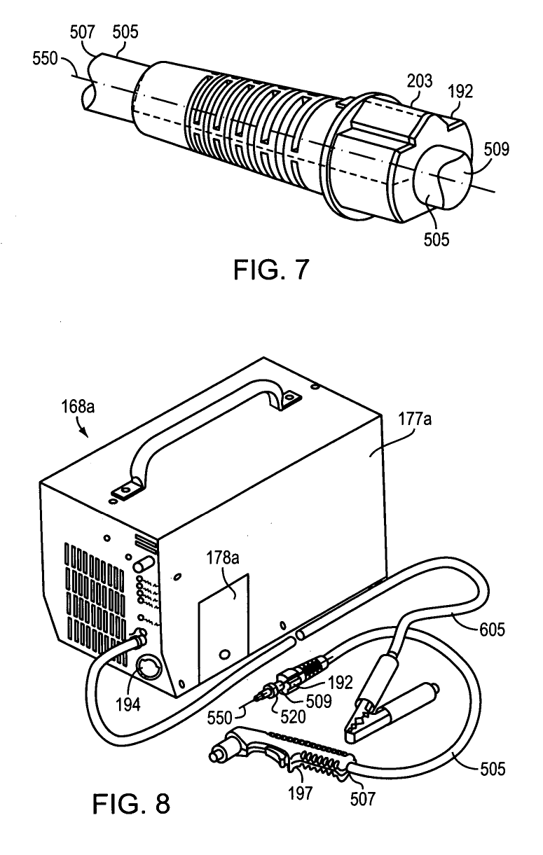

FIG. 7 depicts a positive rotational restraint component 192 and FIG. 8 depicts a plasma arc torch system including a power supply 168a, a lead 505, a connector 520, a positive rotational restraint component 192, and a torch body 197 used for cutting or piercing a metal work piece. The positive rotational restraint component 192 restrains rotational movement of the lead 505 relative to the power supply 168a housing. The positive rotational restraint component 192 can be disposed, for example, adjacent a connector 520, adjacent a connector assembly, or on the lead 505.

In one embodiment, a positive rotational restraint component 192 is disposed on the elongated body of the lead 505 and the positive rotational restraint component 192 restrains rotational movement of the lead 505 relative to the power supply 168a. In another embodiment, the second end 509 of the lead 505 is disposed on the power supply 168a. In another embodiment, the second end 509 of the lead 505 is adjacent a connector 520. The positive rotational restraint component 192 can be independent from the connector 520. As described above, in one embodiment, the connector 520 engages with a mated connector positioned on a housing, such as, referring to FIGS. 3A-3B, 4A-4B, and 6A-6B, the housing member 160 located inside the power supply 168 housing. The connector 520 defines a fluid passageway and is optionally configured to prevent fluid flow through the fluid passageway when the connector 520 is not engaged. The connector 520 can form a connector assembly with a mated connector. A locking member integral to or separate from the connector 520 can, upon application of a translational force, engage the connector 520 with a mated connector to form a connector assembly. The application of a linear force to the locking member at an angle relative to the longitudinal axis 550 causes disengagement of the connector 520 and its mated connector. The mated connector can define a fluid passageway and is optionally configured to prevent fluid flow through the fluid passageway when the connector 520 and the mated connector are not engaged.

In one embodiment, the positive rotational restraint component 192 includes a shaped boot 203 attached to the lead 505. In another embodiment, the positive rotational restraint component 192 includes the shaped boot 203 and a mating receptacle 194 formed in the power supply 168a housing. The shaped boot 203 and the mating receptacle 194 are designed to prevent rotation of the lead 505 when the shaped boot 203 is inserted in the mating receptacle 194. The shaped boot 203 and mating receptacle 194 are designed to have anti-rotation features to prevent rotation of the lead 505 relative to the power supply 168a housing. In another embodiment (not shown), multiple leads (e.g., more than one fluid lead) are disposed through the positive rotational restraint component 192 through, for example, the shaped boot 194.

The positive rotational restraint component 192 is arranged in a spaced relationship relative to a longitudinal axis 550 of the lead 505. In addition, the connector 520 and the positive rotational restraint component 192 can be configured so that both are engaged simultaneously when the lead 505 is connected to the power supply 168a housing by, for example, engagement of the connector 520 with its mated connector.

FIG. 8 illustrates a plasma arc torch system representative of any of a variety of models of torch systems. A torch body 197 configured for hand cutting is connected to the power supply 168a by a single lead 505. The power supply 168a is enclosed by a housing. The lead 505 is connected to the power supply 168a by a connector 520. The positive rotational restraint component 192 prevents rotation of the lead 505 relative to the power supply 168a housing when the positive rotational restraint component 192 is inserted into the mating receptacle 194. The lead 505 provides the torch body 197 with a plasma gas from a gas source (not shown) and electrical power from the power supply 168a to ignite and sustain a plasma stream. In one embodiment, air is used as the plasma gas, but other gases can be used to improve cut quality on metals such as stainless steel and aluminum. A workpiece lead 605 provides a return path for the current generated by the power supply 168a and is typically connected to a workpiece (not shown) by a clamp 225.

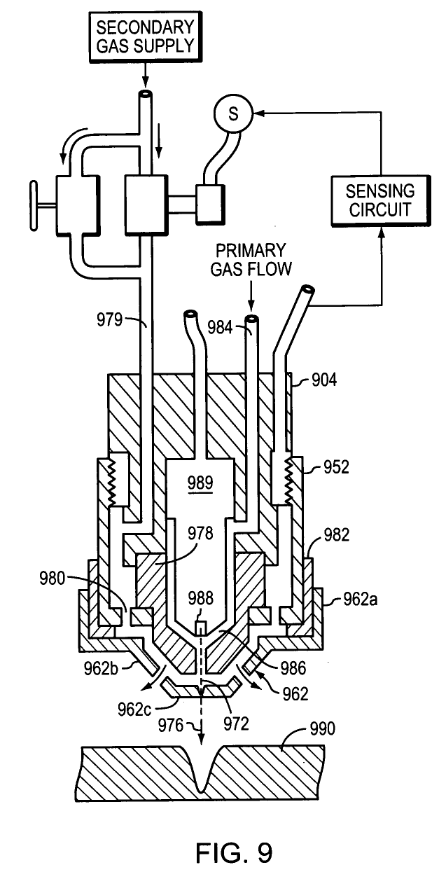

FIG. 9 illustrates, in simplified schematic form, a plasma arc torch representative of any of a variety of models of torches. For example, the plasma arch torch system described in conjunction with FIG. 8 can include the features described in conjunction with FIG. 9. The torch has a body 904 which is generally cylindrical with an exit orifice 972 at a lower end. A plasma arc 976, i.e. an ionized gas jet, passes through the exit orifice 972. The torch is used to pierce and cut metal, such as mild steel or other electrically-conducting materials, in a transferred arc mode. In cutting mild steel, the torch operates with a reactive gas, such as oxygen or air, or a non-reactive gas, such as nitrogen or argon, as the plasma gas to form the transferred plasma arc.

The torch body 904 supports an electrode 989 having an insert 988 in its lower end and a nozzle 978 spaced from the electrode 989. The nozzle 978 has a central orifice that defines the exit orifice 972. In operation, the plasma gas flows through a plasma gas inlet tube 984. The plasma gas flows into the plasma chamber 986 and out of the torch through the exit orifice 972. A pilot arc, which ionizes the plasma gas passing through the exit orifice 972, is first generated between the electrode 989 and the nozzle 978. The arc then transfers from the nozzle 978 to a workpiece 990. A retaining cap 952 substantially encloses the outer surface of the nozzle 978 and is mounted on the torch body 904. A shield 962 (i.e., 962a, 962b, and 962c) has a central circular opening and is aligned with the nozzle 978. An insulating ring 982 can be disposed between the retaining cap 952 and the shield 962. In one embodiment, (not shown) a swirl ring is mounted to the torch body 904, optionally, the swirl ring 980 has a set of radially offset (or canted) gas distribution holes that impart a tangential velocity component to the plasma gas flow causing it to swirl. This swirl creates a vortex that constricts the arc and stabilizes the position of the arc on the insert. In another embodiment, a secondary gas 979 flows through the torch 904 and passes through space between the nozzle 978 and the shield 962 to provide cooling ports 980 (e.g., canted ports) in the secondary gas 979 flow path, producing a swirling flow that improves cut quality. Other torches can be cooled by liquid such as, for example, water or a water mixture. The particular construction details of the torch body, including the arrangement of components directing of plasma gas, secondary gas, and cooling fluid flows and providing electrical connections can take a wide variety of forms.

The lead between the torch and the power supply can be disconnected from the power supply when repairing or replacing the torch head or the lead. For example, the lead is disconnected from the power supply by applying a linear force to a connector assembly locking member at an angle relative to a longitudinal axis of the connector assembly. In addition, an operator often disconnects the torch from the power supply for convenience during storage or transport of the system. The connector, locking member, and/or connector assembly disposed relative to the housing associated with the power supply can be frequently engaged and/or disengaged without tools, without wear or leakage. The connector, locking member, and/or connector assembly can be engaged and/or disengaged in a short period of time relative to other connectors that, for example, require tools. The connector, locking member, and/or connector assembly avoid incorrect tightening and/or installation that is possible with other connectors that, for example, are threaded.

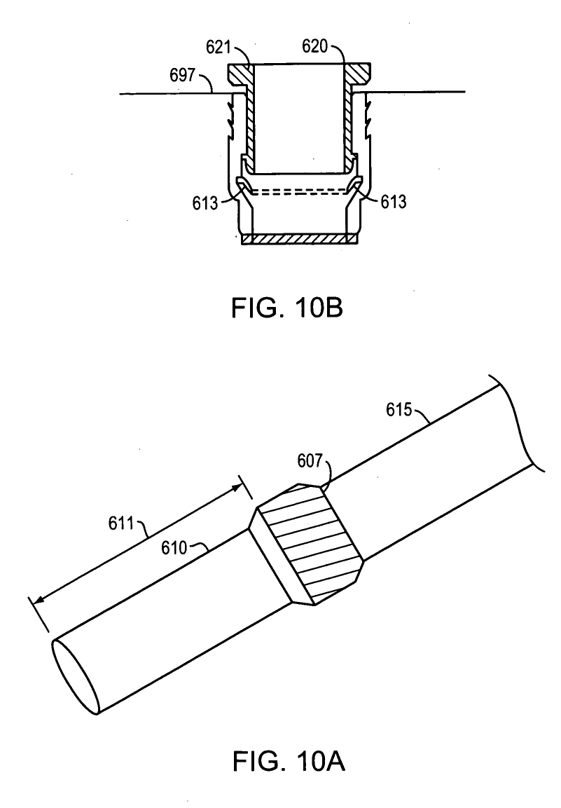

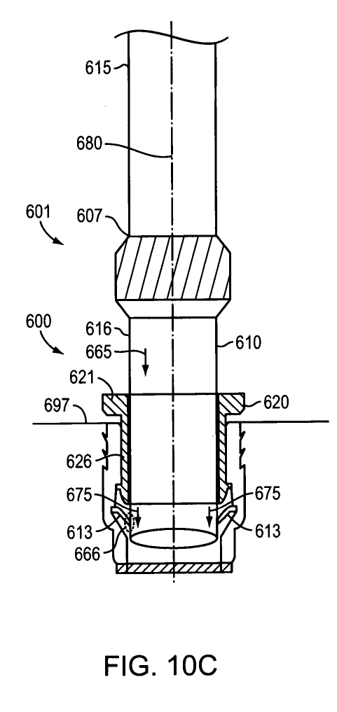

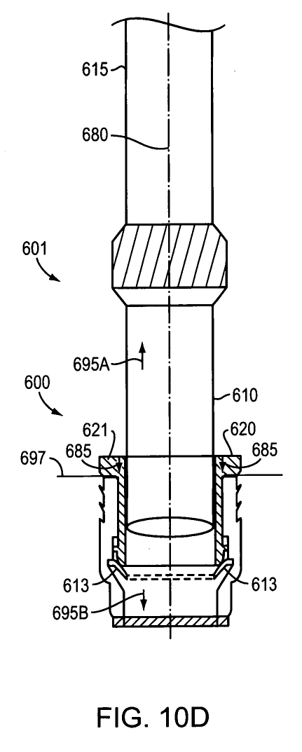

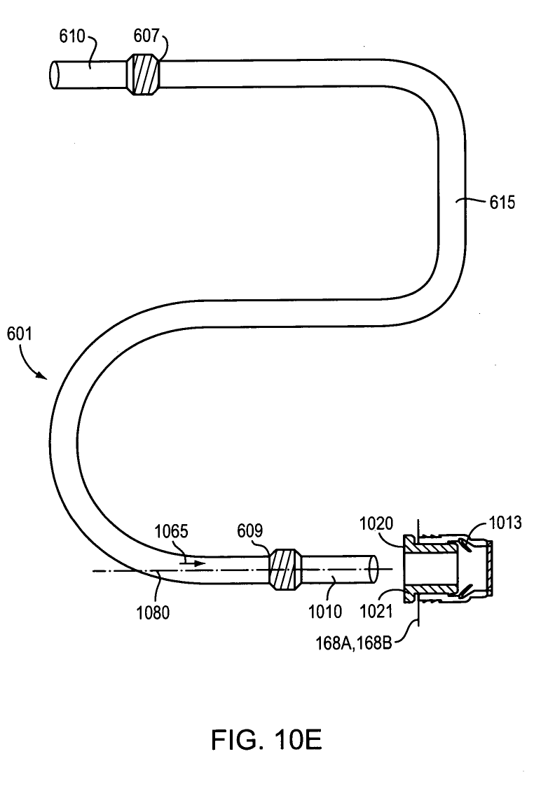

FIGS. 10A-10D illustrate a connector assembly 600 that connects a lead 615 to a plasma arc torch member 697. The connector assembly 600 features a first connector 610 and a second connector 620 that are a mated connector pair. The first connector 610 is disposed on the first end 607 of the lead 615. The first connector 610 is capable of engaging a second connector 620. The first connector 610 causes a compression force 675 in the second connector 620 upon application of a translational force 665 along a longitudinal axis 680 of the lead 615. In one embodiment, referring now to FIG. 10C, the compression force 675 moves one or more deformable member 613 within the second connector 620 such that the one or more deformable member 613 secures the first connector 610 within the second connector 620 at about the region 666. The deformable member 613 can include, for example, at least a portion of an o-ring, a. gasket, and a flexible material (e.g., metal, plastic, and/or combination of these).

Referring now to FIG. 10D, the second connector 620 causes disengagement of the first connector 610 and the second connector 620. Disengagement of the first connector 610 is caused upon application of a depression force 685 to the second connector 620 applied along the longitudinal axis 680. The depression force 685 is applied to, for example, a translational portion 621 of the second connector 620. In one embodiment, the second connector 620 includes one or more deform able member 613 that is adapted to disengage the first connector 610 and the second connector 620 when the depression force 685 is applied, along the longitudinal axis 680, to the second connector 620. For example, a distal end of the translational portion 621 moves one or more deformable member 613 to a new position such that the deformable member 613 releases the first connector 613. In another embodiment, the deformable member 613 is adapted to disengage the first connector 610 and the second connector 620 when a linear force 695 is applied along the longitudinal axis 680 to at least one of the first connector 610 and the second connector 620. For example, the connector assembly 600 is disengaged by applying a depression force 685 to the translational portion 621 of the second connector 620 and subsequently or simultaneously applying to the first connector 610 a linear force 695A in a first direction and applying to the second connector 620 a linear force 695B in a second direction.

The connectors, the compression member, the deformable member, and/or the connector assembly made be made from any suitable materials including, for example, metals (e.g., brass, chrome plated brass, stainless steel, and chrome), plastics (e.g., acetal), a combination of metals and polymers, metal and copolymers, and metal and polymer composites.

In one embodiment, referring now to FIG. 10A the first connector 610 has a tip portion 611 that aids in insertion of the first connector 610 into the second connector 620. The tip portion 611 enables a positive seal between the first connector 610 and the second connector 620. In one embodiment, the tip portion 611 is made from brass.

Suitable connectors and/or connector assemblies that can be used in accordance with the present invention are available from, for example, Legris Connectic (available from Maryland Metrics, Owings Mills, Md.) and, for example, sold under the trade designations CARSTICK and PUSH-TO-CONNECT. Suitable connectors pass flex testing, for example, when installed in a rotating bevel head plasma arc cutting system the connection assembly that connects the lead to the plasma arc torch member is twisted and rotated for 30,000 cycles that twist and bend the lead. The connectors and the connection assembly pass the flex testing because there is no observed degradation of the lead and/or the connection assembly after the 30,000 cycles. Suitable connectors pass high current/high duty cycle testing that exposes the lead set (e.g., the connector and/or the connection assembly and the lead) to a current level that is 20% higher than the current level in the field for 1,000 hours on the arc setting. The lead set passes the high current/high duty cycle testing when there is no observed thermal related failure. Suitable connectors pass a flow test that requires that the connection assembly does not have a greater pressure drop than existing connectors (e.g., connectors requiring tools). In one embodiment, suitable connectors and/or connector assemblies have a pressure drop of less than 0.1 kPa when tested at 29 psi for seven seconds.

In other embodiments, the connectors and/or connector assemblies can include ball and cage style connectors and connector pairs. Such connectors and connector assemblies provide quick, tool free, and leak free connections. Suitable ball and cage style connectors and connector pairs are available from, for example, Parker Quick Coupling Division (Minneapolis, Minn.) and Foster Manufacturing Co., Inc. (Springfield, Mo.). Features of the connectors and connection assemblies described herein (e.g., locking members, ball, cage, o-ring, deformable member, and valve) can be interchanged or added on to one another to provide additional connectors and connection assemblies that combine one or more of the described connector and connection assembly features.

Referring still to FIG. 10A, the first connector 610 is attached to the first end 607 of the lead 615 by any suitable method. For example, the first end 607 of the lead 615 is attached to the first connector 610 by, for example, mechanical means (e.g., tension, compression, pressure), chemical means (e.g., adhesive bonding), or thermal means (e.g., heat bonding). Optionally, the first end 607 of the lead 615 is held within a lumen within the first connector 610 by, for example, suitable mechanical, chemical, or thermal means.

Referring now to FIG. 10B, the second connector 620 is disposed on a plasma arc torch member 697 by any suitable method. For example, by mechanical (e.g., tension, compression, pressure), chemical, or thermal means. Optionally, the second connector 620 has a threaded exterior and is attached to the plasma arc torch member 697 by a threaded connection.

In one embodiment, referring now to FIG. 10C, the first connector 610 defines a first fluid passageway 616 and is optionally configured to prevent flow through the first fluid passageway 616 when the first connector 610 is disengaged. The second connector 620 defines a second fluid passageway 626 and is optionally configured to prevent flow through the second fluid passageway 626 when the first connector 610 is disengaged. When the first connector 610 is engaged with the second connector 620 a connector assembly 600 is formed through which fluid passes. Fluids that can flow through the leads 615 and through the connector assembly 600 include gas and liquids. In addition, power can flow through the leads 615, the first connector 610, the second connector 620 and/or the connector assembly 600. In another embodiment, at least a portion of the lead 615, the first connector 610, the second connector 620 and/or the connector assembly 600 are made from conductive material to enable power flow therethrough.

Referring now to FIG. 10E at lead set 601 includes a first connector 610 disposed on the first end 607 and a third connector 1010 disposed on the second end 609 of the lead 615. The third connector 1010 is capable of engaging a fourth connector 1020 when the third connector 1010 causes a compression force in the fourth connector 620 upon application of a translational force 1065 along a second longitudinal axis 1080 of the lead 615. Disengagement of the third connector 1010 is caused upon application of a depression force to the forth connector 1020 applied along the longitudinal axis 1080. The depression force is applied to, for example, a translational portion 1021 of the fourth connector 1020. In one embodiment, the fourth connector 1020 includes one or more deformable member 1013 that is adapted to disengage the third connector 1010 and the fourth connector 1020 when the depression force is applied, along the longitudinal axis 1080, to the fourth connector 1020.

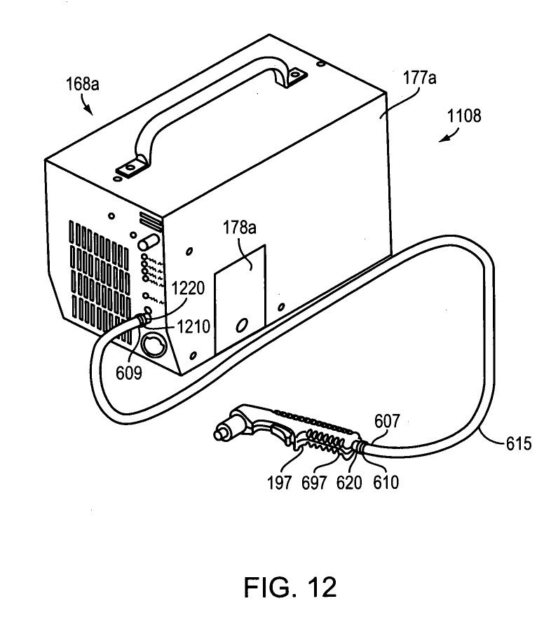

In one embodiment, referring now to FIGS. 10D, 10E, and 12, the lead set 601 first connector 610 is engaged with a second connector 620, disposed on a plasma arc torch member 697, and the third connector 1010 is engaged with the fourth connector 1020, disposed on a power supply 168a. After employing the plasma arc torch, the first connector 610 is disengaged from the second connector 620, thereby removing the lead 615 from the plasma arc torch member 697. The deformable member 613 is adapted to disengage the first connector 610 upon application of a depression force applied along the longitudinal axis 680 to the second connector 620. The third connector 1010 is disengaged from the fourth connector 1020, thereby removing the lead 615 from the power supply 168a. The deformable member 1013 is adapted to disengage the third connector 1010 upon application of a depression force applied along the second longitudinal axis 1080 to the fourth connector 1020.

For example, the connector assembly 600 is disengaged by applying a depression force 685 to the translational portion 621 of the second connector 620 and subsequently or simultaneously applying to the first connector 610 a linear force 695A in a first direction and applying to the second connector 620 a linear force 695B in a second direction. Similarly, the third connector 1010 is disengaged from the fourth connector 1020 by applying a depression force to the translational portion 1021 of the fourth connector 1020 and subsequently or simultaneously applying to the third connector 1010 a linear force that is applied in a first direction (e.g., opposite the translational force 1065). Alternatively or in addition, a linear force is applied to the fourth connector 1020 simultaneous with or subsequent to applying a depression force to the translational portion 1021 of the fourth connector 1020.

The lead set can include a first connector disposed on a first end of the lead that is adapted to mate or engage with a second connector. The lead set also includes a third connector disposed on the second end of the lead that is adapted to mate or engage with a fourth connector. The second connector can be disposed on a plasma arc torch member and the fourth connector can be disposed on a power supply, for example. Suitable connectors, locking members and/or connection assemblies that may be disposed on a first end or on a second end of the lead are described with respect to FIGS. 1, 2A-2B, 3A-3B, 4A-4B, 5A-5B, 6A-6B, 8, and 10A-10D. For example, a lead set includes a first connector disposed on the first end of the lead. The first connector is capable of engaging a second connector when the first connector causes a compression force in the second connector upon application of a translational force along a longitudinal axis of the lead. Disengagement of the first connector is caused upon application of a depression force to the second connector applied along the longitudinal axis. A third connector disposed on the second end of the lead is capable of engaging a fourth connector via a locking member upon application of a translational force along a second longitudinal axis of the lead. The locking member causes, upon application of a linear force at an angle relative to the second longitudinal axis, disengagement of the third connector from the fourth connector. The locking member can further include a planar member that is adapted to disengage the third connector upon application of a linear force applied to the planar member at an angel perpendicular to the second longitudinal axis.

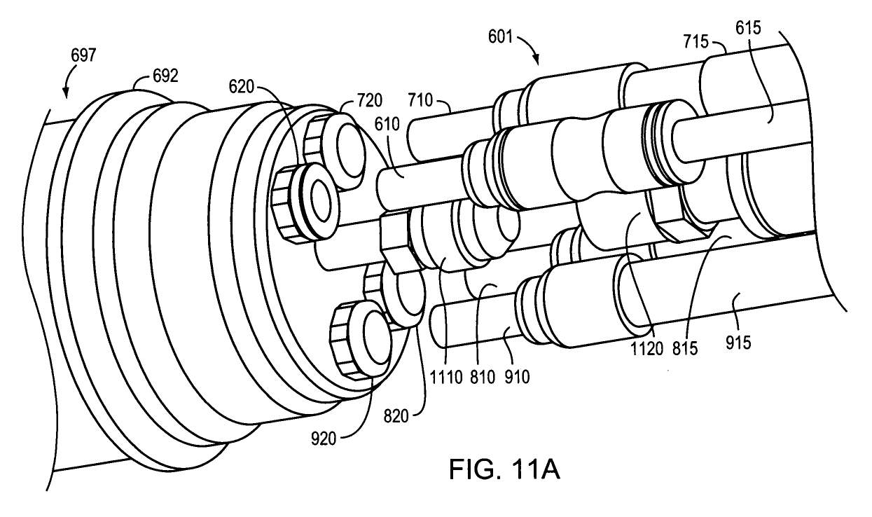

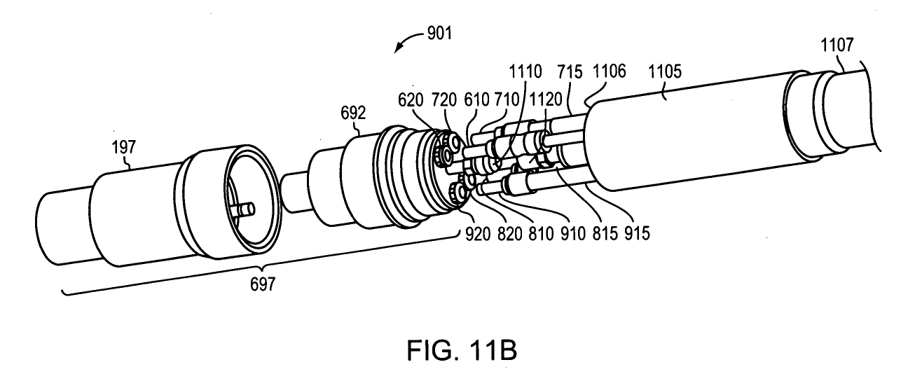

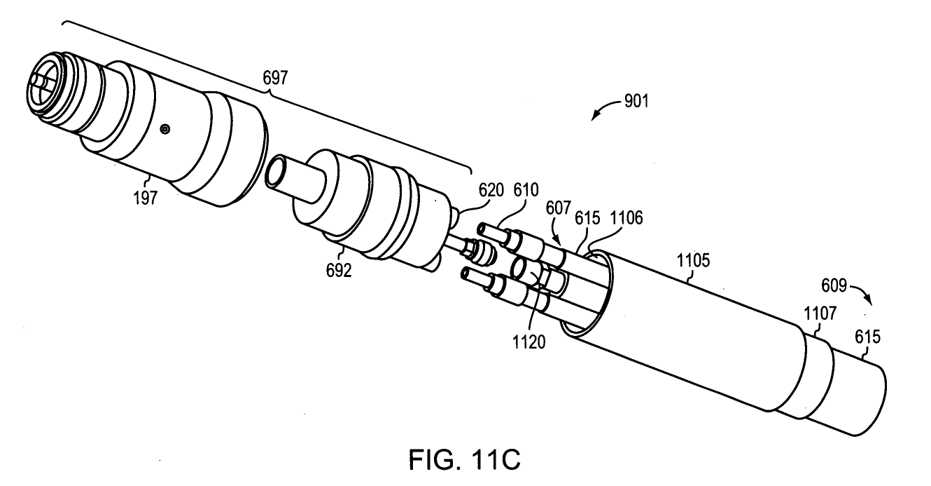

FIGS. 11A-11C, illustrate a plurality of leads 615, 715, 815, 915 on the first end of each lead is disposed a first connector 610, 710, 810, 910 capable of engaging a second connector 620, 720, 820, 920 upon application of a translational force along a longitudinal axis of each lead, 615, 715, 815, 915. The plurality of second connectors 620, 720, 820, 920 are disposed on a plasma arc torch member 697. Referring now to FIG. 11A, the lead set 601 first connector 610 is capable of engaging a second connector 620. The second connector 620 is disposed on a coupler 692 of the plasma arc torch member 697. The first connector 610 causes a compression force in the second connector 620 upon application of a translational force along a longitudinal axis of the lead 615. Disengagement of the first connector 610 is caused upon application of a depression force to the second connector 620 applied along the longitudinal axis of the lead 615. Thus, the second connector 620 causes disengagement of the first connector 610 and the second connector 620. The lead set 601 has a second lead 715 with a first connector 710 capable of engaging a second connector 720. The second connector 720 is disposed on a coupler 692 of the plasma arc torch member 697. The first connector 710 causes a compression force in the second connector 720 upon application of a translational force along a second longitudinal axis of the second lead 715. Disengagement of the first connector 710 is caused upon application of a depression force to the second connector 720 applied along the longitudinal axis of the lead 715. Thus, the second connector 720 causes disengagement of the first connector 710 and the second connector 720. The lead set 601 has a third lead 815 with a first connector 810 that is capable of engaging and disengaging the second connector 820 and a fourth lead 915 with a first connector 910 that is capable of engaging and disengaging the second connector 920 in a manner similar to the connectors 610 and 620 and 710 and 720, respectively.

FIG. 11B illustrates the plasma arc torch member 697, which includes a torch body 197 and a coupler 692. In one embodiment, the coupler 692 is held within a portion of the torch body 197 (e.g., within an end portion of the torch body 197). One or more of the plurality of leads 615, 715, 815, 915 is engaged to and disengaged from plasma arc torch member 697 by a first connector 610, 710, 810, 910 and a second connector 620, 720, 820, 920, respectively. Referring now to FIGS. 11A and 11B, a first twist connector 1110 is disposed relative to the plasma arc torch member 697 and a second twist connector 1120 is disposed relative to the lead set 601. The first twist connector 1110 and the second twist connector 1120 are capable of engaging. For example, the first twist connector 1110 is a male connector that fits inside of the second twist connector 1120, a female connector. In one embodiment, a portion of the second twist connector 1120 is moved about the first twist connector 1110 thereby causing engagement. Optionally, the first twist connector 1110 and the second twist connector 1120 feature complementary threads, for example, a portion of the second twist connector 1120 featuring threads is moved about the a portion of the first twist connector 1110 featuring complementary threads. The second twist connector 1120 can be engaged with and disconnected from the first twist connector 1110 using, for example, one or more fingers and/or one or more tools. In one embodiment, the second twist connector 1120 is disposed on a tube member that is also housed within a lumen 1106 of the sleeve 1105. In another embodiment, at least a portion of one or more of the leads 615, 715, 815, 915 are also housed within a lumen 1106 of the sleeve 1105.

FIG. 11C illustrates at least a portion of a plurality of leads (e.g., 615) and at least a portion of the tube member (on which the second twist connector 1120 is disposed) is held within the lumen 1106 of the sleeve 1105. In one embodiment, a strain relief member 1107 is disposed on an end of the sleeve 1105. In another embodiment, a strain relief member 1107 is disposed within at least a portion of the sleeve 1105 lumen 1106. The strain relief member 1107 can be flexible or inflexible. In one embodiment, the strain relief member 1107 is a coil. The strain relief member 1107 can be made from any suitable materials, including, for example, metals, polymers, composites thereof, and combinations thereof. The strain relief member 1107 protects the leads (e.g., 615) when the plasma arc torch member 697 is moved in various positions (e.g., when the plasma arc torch member 697 is in a vertical position). For example, the strain relief member 1107 prevents a portion of one or more of the leads (e.g., 615) that exit an end of the sleeve 1105 lumen 1106 from bending at angle that pinches the leads to a sharp radius. The strain relief member 1107, by preventing at least some lead bending, avoids lead wear, for example, it avoids wear of an insulating cover on the lead that might allow lead wires to become exposed.

Referring now to FIGS. 11B and 11C, the plasma arc torch member 697 includes a torch body 197 and a coupler 692. In one embodiment, the coupler 692 is held within a portion of the torch body 197 (e.g., within an end portion of the torch body). The coupler 692 can, in one embodiment, be an insulator that insulates the torch body. Because the second connectors (e.g., 620) are disposed on the distal end of the plasma arc torch member 697 (e.g., on the coupler 692) the length of the sleeve 1105 can be reduced, because space required to accommodate the tools and the range of motion of tools for connection and disconnection of the connector assembly is no longer necessary. Thus, the length of the sleeve 1105 can be reduced by an amount ranging from about 0.5% to about 40%, from about 10% to about 30%, or about 25% relative to a connection application requiring tools. Similarly, the diameter of the sleeve 1105 can similarly be reduced by an amount ranging from about 0.5% to about 40%, from about 10% to about 30%, or about 25% relative to a connection application requiring tools.

Additional leads and/or connector assemblies can be positioned or be given design features, for example, they can be sized or colored to ensure connection of mated connectors and to avoid incorrect engagement. In one embodiment, the first connector 610 has a first feature and the third connector 710 has a second feature. The first feature and the second feature can be one or more of color, size, material, weight, gender, and conductivity. The first connector 610 first feature can be different from the third connector 710 second feature. For example, in one embodiment, the first connector 610 is a first color and the third connector 710 is a second color different from the first color. In addition, the second connector 620 is the first color and the fourth connector 720 is the second color. In another embodiment, for example, referring now to FIGS. 10D-10E, the first connector 610, second connector 620, third connector 1010, fourth connector 1020, and lead 615 can be colored the same color. Such a design can indicate to the user that the first connector 610 and the second connector 620 are mated connectors and the third connector 1010 and the fourth connector 1020 are mated connectors and, optionally, that the first connector 610 can also mate with the fourth connector 1020 and the third connector 1010 can also mate with the second connector 620. Alternative designs and features that avoid incorrect engagement include using different connector materials (e.g., plastic and metal) or using differently sized connectors and/or leads. The leads and/or the connector assemblies can be designed to avoid incorrectly engaging the leads with, for example, the wrong connector assembly or with an incorrect fluid source. For example, leads that transport gases, liquids, and power can be sized and/or colored or given other design features that indicate what they transport. Other design features that avoid incorrect engagement include, for example, varying materials, textures, size of connector assemblies, and other design options known to the skilled person. Optionally, keys and/or keysets can be employed on the leads and/or on the connectors to avoid incorrect engagement. The number of connector assemblies, the position of one or more connector assembly disposed on a power supply and/or a plasma arc torch member (e.g., each of a female connector and a male connector are disposed on the power supply and the plasma arc torch member) can be selected in accordance with the specific plasma arc torch member and/or power supply.

Suitable first connectors 610, 710, 810, 910, second connectors 620, 720, 820, 920, and/or connector assemblies can be engaged and/or disengaged with or without tools. In a tool free method of connection, referring now to FIG. 10C, the first connector 610 is engaged with a second connector 620 by one or more fingers on a single hand that, for example, grasps the first connector 610 and applies a translational force 665 along the longitudinal axis 680 of the lead 615, which causes a compression force 675 in the second connector 620. Referring now to FIG. 10D, the first connector 610 and the second connector 620 can be disengaged by one or more fingers on a single hand that presses the second connector 620 at, for example, the translatable portion 621 thereby causing a depression force 685. In one embodiment, application of a depression force 685 along the longitudinal axis 680 to the translatable portion 621 of the second connector 620 causes the deformable member 613 to disengage the first connector 610 from the second connector 620. In another embodiment, the connector assembly 600 is disengaged by applying a depression force 685 to the second connector and applying a linear force 695 along the longitudinal axis 680 to at least one of the first connector 610 and the second connector 620. For example, a single finger of one hand applies a depression force 685 to the translational portion 621 of the second connector 620 and two or more other fingers on the same hand apply a linear force 695B to the second connector 620 (e.g., the linear force 695B is in a direction opposite the translational force 665 shown in FIG. 10C) thereby causing the second connector 620 to be disengaged and separated from the first connector 610. Because the first connectors 610 and the second connectors 620 can be engaged and/or disengaged with a users hands, they are easy to use. The area around the connection assembly 600 does not need to accommodate tools or the range of motion required by tools, rather, the area surrounding the connection assembly 600 must accommodate one or more fingers of an operator. Thus the lead set saves both time required to engage and/or disengage the connection assembly 600 and reduces and/or eliminates the tools required to perform connection and disconnection tasks as compared to a connection requiring tools. Thus, the connection assembly 600 reduces the time required for, for example, assembly, repair, changing lead size, and changing lead type. In addition, because the number of tools required to engage and/or disengage the connection assembly 600 is reduced and/or eliminated the installation, repair, and change complexity are also reduced.

Referring now to FIGS. 10C, 10D, and 12, in another aspect, the invention relates to a plasma arc torch system 1108 including a plasma arc torch member 697, a lead 615 including an elongated body, a first end 607, and a second end 609. A second connector 620 is disposed relative to the torch member 697. A first connector 610 is disposed on the first end 607 of the lead 615. The first connector 610 engages the second connector 620 by causing a compression force in the second connector 620 upon application of a translational force 665 along a longitudinal axis 680 of the lead 615 (see, FIG. 10C). In one embodiment, the second connector 620 causes, upon application of a depression force 685 along the longitudinal axis 680, disengagement of the first connector 610 (see, FIG. 10D). The plasma arc torch system 1108, referring to FIG. 12, can include a power supply 168a.

In one embodiment, a fourth connector 1220 is disposed on the power supply 168a and a third connector 1210, disposed on the second end 609 of the lead 615, is adapted to mate with the fourth connector 1220 along a second longitudinal axis. In one embodiment, referring also to FIGS. 1 and 2A-2B, a locking member (e.g., 130) causes, upon application of a translational force, engagement of the third connector 1210 and the fourth connector 1220. The locking member causes, upon application of a linear force at an angle relative to the second longitudinal axis, disengagement of the third connector 1210 and the fourth connector 1020.

In another embodiment, referring now to FIGS. 10C, 10D, 10E, and 12 the third connector 1210 engages the fourth connector 1220 by causing a compression force in the fourth connector 1220 upon application of a translational force along the second longitudinal axis. The fourth connector 1220 causes, upon application of a depression force along the second longitudinal axis, disengagement of the third connector 1210.

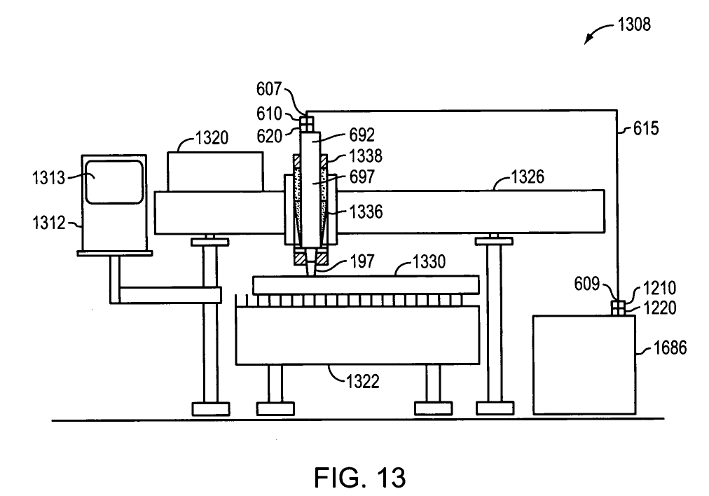

FIG. 13 is a schematic diagram of a plasma arc torch system 1308 for automatically cutting a metallic work piece. The automated plasma arc torch system includes a plasma arc torch member 697, an associated power supply 168b, a computerized numeric controller (CNC) 1312, display screen 1313, an automatic process controller 1336, a torch height controller 1338, a drive system 1320, a cutting table 1322, a gantry 1326, a gas supply (not shown), and a positioning apparatus (not shown). In operation, the tip of the plasma arc torch body 197 is positioned proximate the work piece 1330 by the positioning apparatus.

In operation, a user places a work piece 1330 on the cutting table 1322 and mounts the plasma arc torch member 697 torch body 197 on the positioning apparatus to provide relative motion between the tip of the torch body 197 and the work piece 1330 to direct the plasma arc along a processing path. The torch height control 1338 sets the height of the plasma arc torch member 697 relative to the work piece 1330. Referring now to FIG. 11C, in one embodiment, the torch height control 1338 grasps the sleeve 1105. In one embodiment, at least a portion of the coupler 692 is held within the lumen 1106 of the sleeve 1105 and, when the sleeve is grasped by the torch height control 1338, at least a portion of the coupler 692 is held by the torch height control 1338.

In one embodiment, one or more leads (e.g., 615) are enclosed by a sleeve and a strain relief member (not shown). The strain relief member protects the leads from wear caused by bending at an angle that pinches the lead when the plasma arc torch member 697 is moved in various positions (e.g., when the plasma arc torch member 697 is in a vertical position).

The user provides a start command to the CNC 1312 to initiate the cutting process. The drive system 1320 receives command signals from the CNC 1312 to move the torch body 197 in an x or y direction over the cutting table 1322. The cutting table 1322 supports a work piece 1330. The plasma arc torch member 697 is mounted to the torch height controller 1338 which is mounted to the gantry 1326. The drive system 1320 moves the gantry 1326 relative to the table 1322 and moves the plasma arc torch member 697 along the gantry 1326.

The CNC 1312 directs motion of the plasma arc torch member 697 and/or the cutting table 1322 to enable the work piece 1330 to be cut to a desired pattern. The CNC 1312 is in communication with the positioning apparatus. The positioning apparatus uses signals from the CNC 1312 to direct the torch body 197 of the torch member 697 along a desired cutting path. Position information is returned from the positioning apparatus to the CNC 1312 to allow the CNC 1312 to operate interactively with the positioning apparatus to obtain an accurate cut path.

The power supply 168b provides the electrical current necessary to generate the plasma arc. The main on and off switch of the power supply 168b can be controlled locally or remotely by the CNC 1312. Optionally, the power supply 168b also houses a cooling system for cooling the torch body 197 of the plasma arc torch member 697.

Referring now to FIGS. 10C, 10D, and 13, in the plasma arc torch system 1308, the plasma arc torch member 697 is connected to the power supply 168b by the lead 615. For example, the power and/or cooling water travel from the power supply 168b to the plasma arc torch member 697 via lead 615. The lead 615 includes an elongated body, a first end 607, and a second end 609. A second connector 620 is disposed relative to the torch member 697. A first connector 610 is disposed on the first end 607 of the lead 615. The first connector 610 engages the second connector 620 by causing a compression force in the second connector 620 upon application of a translational force 665 along a longitudinal axis 680 of the lead 615 (see, FIG. 10C). In one embodiment, the second connector 620 causes, upon application of a depression force 685 along the longitudinal axis 680, disengagement of the first connector 610 (see, FIG. 10D).

In one embodiment, a fourth connector 1220 is disposed on the power supply 168b and a third connector 1210, disposed on the second end 609 of the lead 615, is adapted to mate with the fourth connector 1220 along a second longitudinal axis. In one embodiment, referring also to FIGS. 1 and 2A-2B, a locking member (e.g., 130) causes, upon application of a translational force, engagement of the third connector 1210 and the fourth connector 1220. The locking member causes, upon application of a linear force at an angle relative to the second longitudinal axis, disengagement of the third connector 1210 and the fourth connector 1020.

In another embodiment, referring now to FIGS. 10C, 10D, 10E, and 13 the third connector 1210 engages the fourth connector 1220 by causing a compression force in the fourth connector 1220 upon application of a translational force along the second longitudinal axis. The fourth connector 1220 causes, upon application of a depression force along the second longitudinal axis, disengagement of the third connector 1210. The plasma arc torch systems 1108 and 1308 described in FIGS. 12 and 13, respectively, may be employed in bevel cutting applications, for example.

FIG. 9, described above, illustrates, in simplified schematic form, a plasma arc torch representative of any of a variety of models of torches. For example, the plasma arch torch system described in conjunction with FIGS. 12 and 13 can include the features described in conjunction with FIG. 9. For example, the plasma arc torch member can include the torch body 904, and a coupler. In one embodiment, a nozzle 978 is mounted at the first end of the torch body 904 and an electrode 989 is mounted at the first end of the torch body 904 in a mutually spaced relationship with the nozzle 978 to define a plasma chamber 986. A retaining cap 952 mounted on the torch body 904 substantially encloses the outer surface of the nozzle 978. A shield 962 having a central circular opening is aligned with the nozzle 978.

In another aspect, referring to FIGS. 10A-10C, the invention relates to a method for connecting and disconnecting a lead to a plasma arc torch. The method includes manipulating a first connector 610 disposed on a first end 607 of the lead 615 relative to a second connector 620 disposed on the plasma arc torch member 697, by performing at least one of (1) applying to the first connector 610 a translational force 665 along a longitudinal axis 180 of the lead 615 causing a compression force 675 in the second connector 620 that engages the first connector 610 and the second connector 620 or (2) applying to the second connector 620 a depression force 685 along the longitudinal axis 180 that disengages the first connector 610 and the second connector 620. One embodiment of the method also includes, applying a linear 695A, 695B, force along the longitudinal axis 180 to at least one of the first connector 610 and the second connector 620 and disengaging the first connector 610 and the second connector 620. In one embodiment of the method, the first connector 610 defines a fluid passageway 616 and is configured to prevent flow through the fluid passageway 616 when the first connector 610 is disengaged, alternatively or in addition, the second connector 620 defines a fluid passageway 626 and is configured to prevent flow through the fluid passageway 626 when the second connector 620 is disengaged. When the first connector 610 is engaged with the second connector 620 forming a connector assembly 600 there is a fluid passageway through the connector assembly 600.

Referring also to FIGS. 12 and 13, the method can also include disposing, relative to a power supply 168a, 168b comprising a housing, a fourth connector 1220 adapted to mate with a third connector 1210 disposed on the second end 609 of the lead 615. In one embodiment, the third connector 1210 is manipulated relative to the fourth connector 1220 with one of a translational force or a depression force to engage or disengage the third connector 1210 and the fourth connector 1220. In another embodiment, the third connector 1210 and the fourth connector 1220 are manipulated relative to a locking member with one of a translational force or a linear force to engage or disengage the third connector and the fourth connector.

Tools can optionally be used to engage or disengage the first connectors 610, second connectors 620, and/or connector assemblies 600, however, tools are not required to engage or disengage the connectors and/or the connector assembly. Accordingly, the plasma arc torch member 697, the coupler 692, the power supply 168a, 168b and/or the housing 177a associated with the power supply 168a can be sized and arranged without requiring space for tools to fit and have a necessary range of motion. Rather, the size and arrangement of the plasma arc torch 197 and/or the power supply 168a, 168b, accommodates one or more fingers to engage and to disengage a connector assembly 600. The placement of the connectors and/or connector assembly on the plasma arc torch and/or the power supply is accordingly more flexible then when tools are required. For example, one or more operator fingers can be used to engage and/or disengage the connector. Thus, the power supply 168a, 168b, and/or the associated housing and/or the plasma arc torch member 697 requires less access space then when connectors, locking members, and connector assemblies requiring tools for engagement and/or disengagement are employed. In some embodiments, the connectors (e.g., 610, 620) and/or the connector assembly (e.g., 600) are designed for frequent and multiple engagements and disengagements. The connector(s) and/or connector assembly employed in accordance with the present invention require less time for engagement and disengagement when compared with devices requiring tools.

### EQUIVALENTS

While the invention has been particularly shown and described with reference to specific preferred embodiments, it should be understood by those skilled in the art that various changes in form and detail can be made therein without departing from the spirit and scope of the invention as defined by the appended claims. For example, alternative connector structures that require translational force for engagement and a linear force for disengagement of connectors disposed, for example, on an end of a lead and on the power supply are within the scope of the invention. A connector structure defines a fluid passageway and is alternatively configured to prevent fluid flow through the fluid passageway when the connector is not engaged.

1. A lead set for use with a plasma arc torch comprising:
a lead comprising an elongated body, a first end, and a second end; and
a first connector disposed on the first end, the first connector capable of engaging a second connector by causing a compression force in a second connector upon application of a translational force along a longitudinal axis of the lead.

2. The lead set of claim 1 wherein a second connector causing, upon application of a depression force along the longitudinal axis, disengagement of the first connector.

3. The lead set of claim 1 wherein a second connector further comprises a deformable member adapted to disengage the first connector and a second connector upon application of a depression force applied along the longitudinal axis to a second connector.

4. The lead set of claim 3 wherein a deformable member is adapted to disengage the first connector and a second connector upon application of a linear force applied along the longitudinal axis to at least one of the first connector and a second connector.

5. The lead set of claim 1 further comprising:
a third connector disposed on the second end of the lead, the third connector capable of engaging a fourth connector via a locking member upon application of a translational force along a second longitudinal axis of the lead, the locking member causing, upon application of a linear force at an angle relative to the second longitudinal axis, disengagement of the third connector.

6. The lead set of claim 5 wherein the locking member further comprises a planar member adapted to disengage the third connector upon application of a linear force applied to the planar member at an angle perpendicular to the second longitudinal axis.

7. The lead set of claim 1 further comprising:
a third connector disposed on the second end of the lead, the third connector capable of engaging a fourth connector by causing a compression force in a fourth connector upon application of a translational force along a second longitudinal axis of the lead, a fourth connector causing, upon application of a depression force along the second longitudinal axis, disengagement of the third connector.

8. The lead set of claim 7 wherein a second connector and a fourth connector further comprise a first deformable member and a second deformable member adapted to disengage the first connector and the third connector upon application of a depression force applied along the first longitudinal axis and the second longitudinal axis to the second connector and the fourth connector, respectively.

9. The lead set of claim 8 wherein a first deformable member is adapted to disengage the first connector and a second connector upon application of a linear force applied along the longitudinal axis to at least one of the first connector and a second connector and a second deformable member is adapted to disengage the third connector and a fourth connector upon application of a second linear force applied along the second longitudinal axis to at least one of the third connector and a fourth connector.

10. The lead set of claim 1 wherein at least one of the first connector and a second connector defines a fluid passageway and is configured to prevent flow through the fluid passageway when disengaged.

11. The lead set of claim 1 further comprising a second lead comprising an elongated body, a first end, and a second end; and
a third connector disposed on the second lead first end, the third connector capable of engaging a fourth connector by causing a compression force in a fourth connector upon application of a translational force along a second longitudinal axis of the second lead, a fourth connector causing, upon application of a depression force along the second longitudinal axis, disengagement of the third connector.

12. The lead set of claim 11 wherein the first connector comprises a first feature and the third connector comprises a second feature.

13. The lead set of claim 12 wherein the first feature and the second feature are one or more of color, size, material, weight, gender, and conductivity.

14. The lead set of claim 1 further comprising a plurality of additional leads each additional lead having a first end, a second end, and a body; and
a first connector is disposed on each first end, the first connector capable of engaging a second connector by causing a compression force in a second connector upon application of a translational force along a longitudinal axis of each lead.

15. The lead set of claim 14 wherein a second connector causing, upon application of a depression force along the longitudinal axis, disengagement of the first connector.

16. A plasma arc torch system comprising:
a plasma arc torch member;
a second connector disposed relative to the torch member;
a lead comprising an elongated body, a first end, and a second end; and
a first connector, disposed on the first end of the lead, engages the second connector by causing a compression force in the second connector upon application of a translational force along a longitudinal axis of the lead.

17. The plasma arc torch system of claim 16, wherein the second connector causing, upon application of a depression force along the longitudinal axis, disengagement of the first connector.

18. The plasma arc torch system of claim 16, further comprising:
a power supply;
a fourth connector disposed on the power supply;
a third connector, disposed on the second end of the lead, is adapted to mate with the fourth connector along a second longitudinal axis; and
a locking member causing, upon application of a translational force, engagement of the third connector and the fourth connector, the locking member causing, upon application of a linear force at an angle relative to the second longitudinal axis, disengagement of the third connector and the fourth connector.

19. The plasma arc torch system of claim 16, further comprising:
a power supply;
a fourth connector disposed on the power supply;
a third connector, disposed on the second end of the lead, is adapted to mate with the fourth connector along a second longitudinal axis, the third connector engages the fourth connector by causing a compression force in the fourth connector upon application of a translational force along the second longitudinal axis, the fourth connector causing, upon application of a depression force along the second longitudinal axis, disengagement of the third connector.

20. The plasma arc torch system of claim 16, further comprising:
a nozzle mounted at a first end of the torch member;
an electrode mounted at the first end of the torch member in a mutually spaced relationship with the nozzle to define a plasma chamber; and
a retaining cap mounted on the torch member and substantially enclosing the outer surface of the nozzle.

21. The plasma arc torch system of claim 16, further comprising a shield having a central circular opening aligned with the nozzle.

22. The plasma arc torch system of claim 16, wherein the plasma arc torch member comprises a plasma arc torch and a coupler, and the second connector is disposed on the coupler.

23. A method for connecting and disconnecting a lead to a plasma arc torch, comprising:
manipulating a first connector disposed on a first end of the lead relative to a second connector coupled to the plasma arc torch, by performing at least one of:
applying to the first connector a translational force along a longitudinal axis of the lead causing a compression force in the second connector that engages the first connector and the second connector; or
applying to the second connector a depression force along the longitudinal axis that disengages the first connector and the second connector.

24. The method of claim 23 further comprising:
applying a linear force along the longitudinal axis to at least one of the first connector and the second connector; and
disengaging the first connector and the second connector.

25. The method of claim 23 wherein the first connector defines a fluid passageway and is configured to prevent flow through the fluid passageway when the first connector is disengaged.

26. The method of claim 23 wherein the second connector defines a fluid passageway and is configured to prevent flow through the fluid passageway when the second connector is disengaged.

27. The method of claim 23 further comprising:
disposing, relative to a power supply comprising a housing, a fourth connector adapted to mate with a third connector disposed on the second end of the lead; and
manipulating the third connector relative to the fourth connector with one of a translational force or a depression force to engage or disengage the third connector and the fourth connector.

28. The method of claim 23 further comprising:
disposing, relative to a power supply comprising a housing, a fourth connector adapted to mate with a third connector disposed on the second end of the lead; and
manipulating the third connector and the fourth connector relative to a locking member with one of a translational force or a linear force to engage or disengage the third connector and the fourth connector.
